(19) United States
(12) Patent Application Publication
(10) Pub. No.: US 2023/0325690 A1
(43) Pub. Date: Oct. 12, 2023

(54) PREDICTIVE DATA ANALYSIS OPERATIONS USING A HIERARCHICAL INTERVENTION RECOMMENDATION MACHINE LEARNING FRAMEWORK

(71) Applicant: Optum, Inc., Minnetonka, MN (US)

(72) Inventors: Ninad D. Sathaye, Bangalore (IN); Manoj Kapoor, Noida (IN); Gregory J. Boss, Saginaw, MI (US); Raghav Bali, Delhi (IN)

(21) Appl. No.: 17/718,602

(22) Filed: Apr. 12, 2022

(51) Int. Cl. G06N 5/02; G06N 5/04

(52) U.S. Cl. CPC G06N 5/027; G06N 5/04

(57) ABSTRACT

Various embodiments of the present invention provide methods, apparatus, systems, computing devices, computing entities, and/or the like for performing predictive data analysis operations using a hierarchical intervention recommendation machine learning framework. Certain embodiments of the present invention utilize systems, methods, and computer program products that perform predictive data analysis operations using at least one of the techniques using real-time sensory timeseries data object, techniques using global baseline sensory feature data object, techniques using intermediate intervention operations, techniques using real-time risk scores, techniques using intermediate risk scores, and/or the like.

### BACKGROUND

Various embodiments of the present invention address technical challenges related to performing predictive data analysis and disclose innovative techniques for efficiently and effectively performing predictive data analysis operations using a hierarchical intervention recommendation machine learning framework.

### BRIEF SUMMARY

In general, various embodiments of the present invention provide methods, apparatus, systems, computing devices, computing entities, and/or the like for performing predictive data analysis operations using a hierarchical intervention recommendation machine learning framework. Certain embodiments of the present invention utilize systems, methods, and computer program products that perform predictive data analysis using at least one of techniques using real-time sensory timeseries data object, techniques using global baseline sensory feature data object, techniques using intermediate intervention operations, techniques using real-time risk scores, techniques using intermediate risk scores, and/or the like.

In accordance with one aspect, a method is provided. In one embodiment, the method comprises: A computer-implemented method for performing predictive data analysis operations using a hierarchical intervention recommendation machine learning framework, the computer-implemented method comprising: providing a global intermediate intervention score threshold to a primary computing entity, wherein the primary computing entity is configured to: identify a real-time sensory timeseries data object associated with a current prediction window; generate, using a real-time risk scoring machine learning model of the hierarchical intervention recommendation machine learning framework, and based at least in part on the real-time sensory timeseries data object and a global baseline sensory feature data object, a real-time risk score associated with the current prediction window; generate, based at least in part on the real-time risk score, an intermediate intervention score; in response to determining that the intermediate intervention score satisfies the global intermediate intervention score threshold: perform one or more intermediate intervention operations, subsequent to performing the one or more intermediate intervention operations, receive one or more intermediate intervention response features associated with the one or more intermediate intervention operations, generate, using an intermediate risk scoring machine learning model of the hierarchical intervention recommendation machine learning framework, and based at least in part on the one or more intermediate intervention response features, an intermediate risk score, generate, using a risk aggregation machine learning model of the hierarchical intervention recommendation machine learning framework, and based at least in part on the real-time risk score and the intermediate risk score, an adjusted risk score, and perform one or more final intervention operations based at least in part on the adjusted risk score.

In accordance with another aspect, a computer program product is provided. The computer program product may comprise at least one computer-readable storage medium having computer-readable program code portions stored therein, the computer-readable program code portions comprising executable portions configured to: provide a global intermediate intervention score threshold to a primary computing entity, wherein the primary computing entity is configured to: identify a real-time sensory timeseries data object associated with a current prediction window; generate, using a real-time risk scoring machine learning model of the hierarchical intervention recommendation machine learning framework, and based at least in part on the real-time sensory timeseries data object and a global baseline sensory feature data object, a real-time risk score associated with the current prediction window; generate, based at least in part on the real-time risk score, an intermediate intervention score; in response to determining that the intermediate intervention score satisfies the global intermediate intervention score threshold: perform one or more intermediate intervention operations, subsequent to performing the one or more intermediate intervention operations, receive one or more intermediate intervention response features associated with the one or more intermediate intervention operations, generate, using an intermediate risk scoring machine learning model of the hierarchical intervention recommendation machine learning framework, and based at least in part on the one or more intermediate intervention response features, an intermediate risk score, generate, using a risk aggregation machine learning model of the hierarchical intervention recommendation machine learning framework, and based at least in part on the real-time risk score and the intermediate risk score, an adjusted risk score, and perform one or more final intervention operations based at least in part on the adjusted risk score.

In accordance with yet another aspect, an apparatus comprising at least one processor and at least one memory including computer program code is provided. In one embodiment, the at least one memory and the computer program code may be configured to, with the processor, cause the apparatus to: provide a global intermediate intervention score threshold to a primary computing entity, wherein the primary computing entity is configured to: identify a real-time sensory timeseries data object associated with a current prediction window; generate, using a real-time risk scoring machine learning model of the hierarchical intervention recommendation machine learning framework, and based at least in part on the real-time sensory timeseries data object and a global baseline sensory feature data object, a real-time risk score associated with the current prediction window; generate, based at least in part on the real-time risk score, an intermediate intervention score; in response to determining that the intermediate intervention score satisfies the global intermediate intervention score threshold: perform one or more intermediate intervention operations, subsequent to performing the one or more intermediate intervention operations, receive one or more intermediate intervention response features associated with the one or more intermediate intervention operations, generate, using an intermediate risk scoring machine learning model of the hierarchical intervention recommendation machine learning framework, and based at least in part on the one or more intermediate intervention response features, an intermediate risk score, generate, using a risk aggregation machine learning model of the hierarchical intervention recommendation machine learning framework, and based at least in part on the real-time risk score and the intermediate risk score, an adjusted risk score, and perform one or more final intervention operations based at least in part on the adjusted risk score.

### BRIEF DESCRIPTION OF THE SEVERAL VIEWS OF THE DRAWINGS

Reference will now be made to the accompanying drawings, which are not necessarily drawn to scale, and wherein:

FIG. 1 provides an exemplary overview of an architecture that can be used to practice embodiments of the present invention.

FIG. 2 provides an example predictive data analysis computing entity in accordance with some embodiment discussed herein.

FIG. 3 provides an example client computing entity in accordance with some embodiments discussed herein.

FIG. 4 is a flowchart diagram of an example process for performing predictive data analysis operations using a hierarchical intervention recommendation machine learning framework in accordance with some embodiments discussed herein.

FIG. 5 is a flowchart diagram of an example process for generating an adjusted risk score in accordance with some embodiments discussed herein.

FIG. 6 is a flowchart diagram of an example process for determining a real-time risk score in accordance with some embodiments discussed herein.

FIG. 7 provides a flowchart diagram of an example process for generating an intermediate intervention score in accordance with some embodiments discussed herein.

FIG. 8 provides a flowchart diagram of an example process for determining an inferred upward linearity score in accordance with some embodiments discussed herein.

FIG. 9 provides operational examples of a reaction time test in accordance with some embodiments discussed herein.

FIG. 10 provides operational examples of a motor screening test in accordance with some embodiments discussed herein.

FIG. 11 provides operational examples of a modified paired associates learning in accordance with some embodiments discussed herein.

FIG. 12 provides an operational example of an intermediate risk scoring machine learning model in accordance with some embodiments discussed herein.

FIG. 13 provides an operational example of high-importance medical data subset user interface in accordance with some embodiments discussed herein.

FIG. 14 provides an operation example 1400 of a federated learning system according to some embodiments herein.

### DETAILED DESCRIPTION

Various embodiments of the present invention now will be described more fully hereinafter with reference to the accompanying drawings, in which some, but not all, embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout. Moreover, while certain embodiments of the present invention are described with reference to predictive data analysis, one of ordinary skill in the art will recognize that the disclosed concepts can be used to perform other types of data analysis.

### I. Overview and Technical Advantages

Various embodiments of the present invention introduce techniques for improving operational reliability and computational efficiency of intervention recommendation predictive data analysis solutions by using a hierarchical intervention recommendation machine learning framework. As further described herein, a hierarchical intervention recommendation machine learning framework may limit real-time computational operations to those configured to generate an intermediate intervention score which is then used to perform one or more intermediate intervention operations, where executing final risk score determination operations is postponed until after executing one or more intermediate intervention operations. In this way, by utilizing these techniques, a predictive data analysis system can delay execution of some mission-critical operations to after a current time window, thus removing the number of real-time risk scoring operations that need to be performed. Accordingly, by using a hierarchical intervention recommendation machine learning framework, various embodiments of the present invention reduce the real-time operational load on intervention recommendation predictive data analysis solutions and thus improve operational reliability and computational efficiency of intervention recommendation predictive data analysis solutions.

Various embodiments of the present invention disclose techniques for more efficiently and reliably performing predictive data analysis. For example, various embodiments of the present invention disclose techniques for performing predictive data analysis operations utilizing a hierarchical intervention recommendation machine learning framework. For example, according to some embodiments of the present invention, predictive data analysis using a hierarchical intervention recommendation machine learning framework can be performed by: (i) generating a real-time risk score associated with a current prediction window using a real-time risk scoring machine learning model of a hierarchical intervention recommendation machine learning framework, (ii) generating an intermediate risk score using an intermediate risk scoring machine learning model of the hierarchical intervention recommendation machine learning framework, (iii) generating an adjusted risk score using a risk aggregation machine learning model of the hierarchical intervention recommendation machine learning framework based at least in part on the real-time risk score and the intermediate risk score, and (iv) performing one more recommended prediction-based actions (e.g., intervention operations) based at least in part on the adjusted risk score.

At least one or more of the real-time risk scoring machine learning model, intermediate risk scoring machine learning model, and risk aggregation machine learning model of the hierarchical intervention recommendation machine learning framework utilizes training data and prediction operations that may, in at least some embodiments, reduce or eliminate the need for computationally expensive training operations in order to generate the respective risk scores, which in turn are used to perform predictive-based actions (e.g., one or more intermediate interventions and/or one or more final interventions). By reducing or eliminating the noted training operations, various embodiments of the present invention: (i) reduce or eliminate the computational operations needed for training and thus improves the computational efficiency of performing predictive data analysis, (ii) reduce or eliminate the need for storage resources to train/generate real-time risk scoring machine learning models, intermediate risk scoring machine learning models, and/or risk aggregation machine learning models for performing predictive data analysis, and thus improves storage efficiency of performing predictive data analysis, and (iii) reduce or eliminate the need for transmitting extensive training data needed to generate real-time risk scoring machine learning models, intermediate risk scoring machine learning models, and/or risk aggregation machine learning models for performing predictive data analysis and thus improves transmission/network efficiency of performing predictive data analysis. Via the noted advantages, various embodiments of the present invention make substantial technical contributions to the fields of predictive data analysis in particular and healthcare-related predictive data analysis in general.

An exemplary application of various embodiments of the proposed invention relate to predicting potential cognitive impairment (e.g., mild cognitive impairment) with respect to a monitored individual based at least in part on the monitored individual's driving behavior. In-vehicle sensor data (e.g., sensory data captured from one or more sensors located in/on/within a vehicle operated by the monitored individual), patient medical history, claims data, and/or prescription drug information may be utilized to detect early signs of mild cognitive impairment. Furthermore, the noted exemplary application also relates to predicting the impact of a prescription medicine with respect to the corresponding individual based at least in part on historical driving behavior.

Mild cognitive impairment (MCI) is an early stage of memory loss or other cognitive ability loss such as language or visual/spatial perception. Individuals experiencing mild cognitive impairment generally maintain the ability to independently perform most activities of daily living. Notably, mild cognitive impairment causes cognitive changes that are serious enough to be noticed by the person affected and by family members and friends but do not affect the individual's ability to carry out everyday activities. Mild cognitive impairment can develop for multiple reasons, and some individuals living with mild cognitive impairment may later develop dementia. For neurodegenerative diseases, mild cognitive impairment can be an early stage of the disease continuum, including Alzheimer's.

Particularly, mild cognitive impairment, which affects thinking skills other than memory, including the ability to make sound decisions, judge the time or sequence of steps needed to complete a complex task or visual perception could be particularly detrimental to the safety of an individual while operating a moving object (e.g., while driving a vehicle). A compromised driving ability which may include slow response time or degraded decisions (e.g., making wrong turns) poses a potential hazard to the on-road safety of the individual suffering from mild cognitive impairment as well as others on the road.

### II. Definitions of Certain Terms

The term “current prediction window” may describe a data object that describes a time period with respect to which one or more prediction-based actions is determined for a monitored individual based at least in part on one or more risk scores associated with the time period. For example, in the context of a cognitive impairment prediction scenario, a current prediction window may describe a time period with respect to which one or more intervention operations (e.g. intermediate intervention operations, final intervention operations, and/or the like) is determined for a monitored individual based at least in part on one or more risk scores (e.g., real-time risk score, intermediate risk score, adjusted risk score, and/or the like) associated with the time period, where the one or more risk scores may be configured to be used to predict the onset of cognitive impairment and/or detect cognitive impairment (e.g., mild cognitive impairment). In the noted example, a current prediction window may describe a time period of a set of time periods across which a real-time sensory timeseries data object is calculated, where the one or more risk scores is determined based at least in part of the real-time sensory timeseries data object. A current prediction window may be associated with one or more historical prediction windows, where each historical prediction window may describe a previous current prediction window with respect to a given monitored individual. In some embodiments, the desired length of a period of time described by a current prediction window may be a predefined length. In some embodiments, the desired length of a period of time described by a current prediction window may be determined based at least in part on predefined configuration data. In some embodiments, the desired length of a period of time described by a current prediction window may be determined based at least in part on configuration that are dynamically generated.

The term “real-time sensory timeseries data object” may refer to a data entity that describes recorded sensory measurements for a monitored individual over a set of time periods (e.g., a current prediction window). For example, a real-time sensory timeseries data object may include aggregated sensory measurements captured/measured over a set of time periods. Examples of recorded sensory measurements may include one or more physiological condition measurements (e.g., body temperature, body alcohol level, pulse rate, heart rate, blood oxygen level, respiratory functions, sweat, blood pressure, and/or the like), one or more recorded behavioral condition measurements (e.g., eyelid movement, head tilt, eye blinking rate, arm movement, and/or the like), one or more environmental condition measurements (e.g., weather condition, road condition, traffic light status, presence of a stop sign, road work sign, and/or the like, speed limit, moving object proximity with respect to other moving objects, and/or the like), one or more moving object (e.g., vehicle) operation condition measurements (e.g., rate of acceleration, rate of deceleration, steering wheel operation, and/or the like). In some embodiments, a real-time sensory timeseries data object may describe one or more recorded physiological condition measurements, one or more recorded behavioral condition measurements, one or more recorded environmental condition measurements, and/or one or more moving object (e.g., vehicle) recorded operation condition measurements. In some embodiments, a real-time sensory timeseries data object may be input variable to a real-time risk scoring machine that is configured to determine a real-time risk score for a given current prediction window.

The term “real-time risk scoring machine learning model” may refer to a data entity that is configured to describe parameters, hyper-parameters, and/or defined operations of a model that is configured to generate a real-time risk score for a current prediction window for a monitored individual based at least in part on a real-time sensory feature data object (e.g., generated based at least in part on a real-time sensory timeseries data object) and a baseline sensory feature data object. In some embodiments, the real-time risk scoring machine learning model is a supervised machine learning model (e.g., a neural network model) trained using label data, where the supervised machine learning model is configured to generate a real-time risk score for a current prediction window for a monitored individual, and where the real-time risk score is used to determine an intermediate risk score and an adjusted risk score associated with the current prediction window, which are in turn used to determine one or more recommended prediction-based actions. In some embodiments, the real-time risk scoring machine learning model is an unsupervised machine learning model (e.g., a clustering model). In some embodiments, the real-time risk scoring machine learning model is a moving average-based threshold model, such as a model that is configured to determine a real-time risk score based at least in part on whether a moving average of recorded sensory data for a set of time periods exceeds a threshold. In some embodiments, inputs to the real-time risk scoring machine learning model comprise a vector describing a real-time sensory feature data object, while outputs of the real-time risk scoring machine learning model comprise a vector describing a real-time risk score.

The term “real-time risk score” may refer to a data entity that describes a risk score for a monitored individual for a current prediction window, where the risk score is in turn configured to be used to determine an intermediate risk score and an adjusted risk score for the monitored individual. In some embodiments, a real-time risk score for a given current prediction window for a given monitored individual is generated using a real-time risk scoring machine learning model of a hierarchical intervention recommendation machine learning framework. In some embodiments, a real-time risk score may indicate the severity level of a condition associated with the monitored individual. For example, in some embodiments, a real time risk score may indicate cognitive impairment severity with respect to a monitored individual.

The term “intermediate risk score” may refer to a data entity that describes a risk score that is in turn used to determine an adjusted risk score, where the risk score may be generated using an intermediate risk scoring machine learning model of the hierarchical intervention recommendation machine learning framework, and based at least in part on one or more intermediate intervention response features. For example, in some embodiments, an intermediate risk score is generated by an intermediate risk scoring machine learning model (e.g., multivariate timeseries model) of a hierarchical intervention recommendation machine learning framework by processing one or more intermediate intervention response features generated based at least in part on one or more intermediate intervention operations. In some embodiments, an intermediate risk score may be a vector. In some embodiments, an intermediate risk score may be an input variable to a risk aggregation machine learning model of a hierarchical intervention recommendation machine learning framework that is configured to generate an adjusted risk score. In some embodiments, the intermediate risk score may be indicative of the onset of a medical condition (e.g., mild cognitive impairment) with respect to a corresponding monitored individual. For example, in some embodiments, the intermediate risk score may be used to predict a given monitored individual's cognitive impairment state in advance (e.g., 7 days, 15 days, 30 days in advance).

The term “intermediate risk scoring machine learning model” may refer to a data entity that is configured to describe parameters, hyper-parameters, and/or defined operations of a model that is configured to generate an intermediate risk score associated with a current prediction window for a monitored individual based at least in part on one or more intermediate intervention response features. In some embodiments, the intermediate risk scoring machine learning model is configured to score (e.g., generate intermediate risk score) and predict a given monitored individual's cognitive impairment state in advance (e.g., 7 days, 15 days, 30 days in advance). In some embodiments, the intermediate risk scoring machine learning model is a supervised machine learning model (e.g., a neural network model) trained using label data, where the supervised machine learning model is configured to generate an adjusted risk score associated with a current prediction window with respect to a monitored individual. In some embodiments, the real-time risk scoring machine learning model is an unsupervised machine learning model (e.g., a clustering model). In some embodiments the intermediate risk scoring machine learning model is a multivariate timeseries model. In some embodiments, inputs to the intermediate risk scoring machine learning model comprise a vector describing one or more intermediate intervention response features, while outputs of the intermediate risk scoring machine learning model comprise a vector describing an intermediate risk score. In some embodiments, the intermediate risk scoring machine learning model is determined based at least in part on historical intervention efficacy data. In some embodiments, the intermediate risk scoring machine learning model is associated with one or more trainable parameters.

The term “adjusted risk score” may refer to a data entity that describes a risk score that is configured to be used to predict/detect a condition (e.g., a medical condition) associated with a monitored individual, where the risk score may be generated using a risk aggregation machine learning model of the hierarchical intervention recommendation machine learning framework, and based at least in part on a real-time risk score. For example, in some embodiments, an adjusted risk score may describe the cognitive state of a monitored individual. Additionally, an adjusted risk score may be configured to be utilized to determine one or more recommended interventions (e.g., intervention operations) based at least in part on the cognitive state described by the adjusted risk score. For example, a particular adjusted risk score may describe that a corresponding monitored individual is experiencing cognitive impairment. As another example, a particular adjusted risk score may describe that a corresponding monitored individual is experiencing the onset of a cognitive impairment. As yet another example, a particular adjusted risk score may describe that a corresponding monitored individual is not experiencing cognitive impairment. As a further example, a particular adjusted risk score may describe that a corresponding monitored individual is not experiencing the onset of cognitive impairment. In some embodiments, an adjusted risk score is generated by a risk aggregation machine learning model of a hierarchical intervention recommendation machine learning framework by processing a set of risk scores (e.g., a real-time risk score for the current prediction window and an intermediate risk score) associated with the corresponding monitored individual.

The term “risk aggregation machine learning model” may refer to a data entity that is configured to describe parameters, hyper-parameters, and/or defined operations of a model that is configured to generate an adjusted risk score associated with a current prediction window for a monitored individual based at least in part on a real-time risk score and an intermediate risk score. In some embodiments, the real-time risk scoring machine learning model is a supervised machine learning model (e.g., a neural network model) trained using label data, where the supervised machine learning model is configured to generate an adjusted risk score associated with a current prediction window with respect to a monitored individual. In some embodiments, the risk aggregation machine learning model is an unsupervised machine learning model (e.g., a clustering model). In some embodiments, inputs to the risk aggregation machine learning model comprise a vector describing a real-time risk score and an intermediate risk score, while outputs of the risk aggregation machine learning model comprise a vector describing an adjusted risk score. In some embodiments, the risk aggregation machine learning model is determined based at least in part on historical intervention efficacy data. In some embodiments, the risk aggregation machine learning model is associated with one or more trainable parameters.

The term “real-time sensory feature data object” may refer to a data entity that describes one or more real-time sensory features associated with a current prediction window, where a real-time sensory feature value may describe the performance of a monitored individual during the current prediction window with respect to the corresponding real-time sensory feature. In some embodiments, a real-time sensory feature value may (alone or in combination with one or more other sensory feature value) indicate the likelihood potential cognitive impairment. In the some embodiments, examples of real-time sensory features may include a reaction time sensory feature that describes reaction time (e.g., response time) of a monitored individual with respect to an event, braking pattern sensory feature that describes observed braking patterns with respect to a moving object (e.g., vehicle) operated by the monitored individual, alertness sensory feature that describes alertness/attentiveness of a monitored individual, motion pattern sensory features such as lane change pattern, speed/acceleration pattern, and/or the like with respect to a moving object operated by a monitored individual, and/or the like. In some embodiments, a real-time sensory feature may be determined based at least in part on one or more recorded sensory measurements associated with the real-time sensory timeseries data object associated with the current prediction window for a monitored individual. A real-time sensory feature data object is configured to be used to determine a real-time risk score for a current prediction window for a monitored individual.

The term “global baseline sensory feature data object” may refer to a data entity that describes one or more global thresholds corresponding to a real-time sensory feature associated with a real-time sensory feature data object. For example, a particular global threshold may correspond to a particular real-time sensory feature while another particular global threshold may correspond to another (e.g., different) particular real-time sensory feature. For example, a particular global threshold may correspond to a reaction time sensory feature, while another particular threshold may correspond to braking pattern sensory feature. In some embodiments, the global baseline sensory feature data object is configured to perform an evaluation for an evaluation period (e.g., current prediction window). In some embodiments, each global threshold may be determined based at least in part on real-time sensory features across a population segment that are similarly situated with respect to the monitored individual and the current prediction window. For example, in the context of a cognitive impairment prediction, each global threshold may be calculated based at least in part on real-time sensory features of a population of drivers going through similar driving scenarios/conditions as the monitored individual.

The term “intermediate intervention operations” may refer to one or more tests presented to a corresponding monitored individual (e.g., via a user interface associated with a client computing entity associated with a monitored individual), where the one or more tests is configured to assess/evaluate the cognitive state of the monitored individual. Examples of intermediate intervention operations include a reaction time test, a motor screening test, a modified paired associates learning test, and/or the like. In some embodiments, at least one or more responses (e.g., monitored individual's response) to the one or more tests may be configured to be used to predict the onset of cognitive impairment. In some embodiments, one or more intermediate intervention response features determined based at least in part on the responses to the one or more tests may be input variables to an intermediate risk scoring machine learning model of a hierarchical intervention recommendation machine learning framework. In some embodiments, an intermediate intervention operation may be triggered in response to determining that an intermediate intervention score satisfies a global intermediate intervention score threshold (e.g., less than, equal to, and/or above). In some embodiments, an intermediate intervention operation may be triggered in response to determining anomalies (e.g., attentiveness anomalies, and/or the like) with respect to a monitored individual.

The term “intermediate intervention response features” may refer to a data entity that is configured to describe a set of features associated with one or more responses of a monitored individual to one or more intermediate intervention operations (e.g., one or more tests). In some embodiments, the one or more intermediate intervention response features may be input variables to the intermediate risk scoring machine learning model of a hierarchical intervention recommendation machine learning framework configured to generate an intermediate intervention score associated with a current prediction window.

### III. Computer Program Products, Methods, and Computing Entities

Embodiments of the present invention may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations.

Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### IV. Exemplary System Architecture

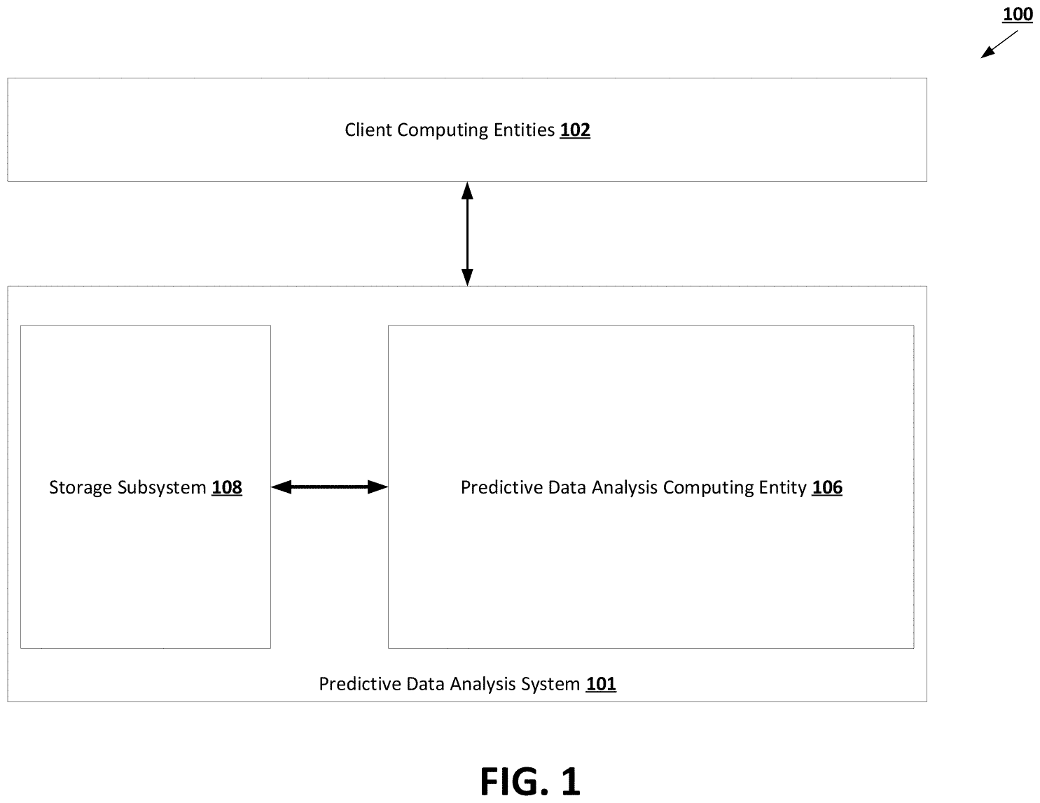

FIG. 1 is a schematic diagram of an example architecture 100 for performing predictive data analysis. The architecture 100 includes a predictive data analysis system 101 configured to perform predictive data analysis. The predictive data analysis system 101 may be configured to perform prediction-based actions. An example of a prediction-based action that can be performed using the predictive data analysis system 101 is cognitive impairment detection (e.g., mild cognitive impairment detection) and recommended intervention operations. Mild cognitive impairment (MCI) is an early stage of memory loss or other cognitive ability loss such as language or visual/spatial perception. Mild cognitive impairment (MCI) can be broadly classified as “Amnestic MCI,” which primarily affects memory or “Non-Amnestic MCI,” which affects thinking skills other than memory, including the ability to make sound decisions, judge the time or sequence of steps needed to complete a complex task or visual perception. Non-Amnestic MCI, especially, could be particularly detrimental to the safety of an individual while operating a moving object (e.g., while driving a vehicle). A compromised driving ability, which may include slow response time or degraded decisions (e.g., making wrong turns), poses a potential hazard to the on-road safety of the individual suffering from mild cognitive impairment, as well as others on the road.

In some embodiments, the predictive data analysis system 101 may be a federated learning system where a global model is trained with decentralized data generated by individual client computing entities (e.g., associated with corresponding monitored individuals). For example, a central server may be configured to receive training data (e.g., encrypted results of training) from each associated client computing entity and aggregate the received training data to generate a global model. Additionally, the central server may implement differential privacy techniques. The central server may control how much training results each vehicle can provide. In some embodiments, the federated learning techniques may comprise determining a global intermediate intervention score threshold based at least in part on sensory data provided by various client computing entities. In some embodiments the federated learning techniques may comprise determining a global threshold for one or more sensory features based at least in part on sensory data provided by various client computing entities.

In some embodiments, predictive data analysis system 101 may communicate with at least one of the client computing entities 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The predictive data analysis system 101 may include a predictive data analysis computing entity 106 and a storage subsystem 108. The storage subsystem 108 may be configured to store input data used by the predictive data analysis computing entity 106 to perform predictive data analysis as well as model definition data used by the predictive data analysis computing entity 106 to perform various predictive data analysis tasks. The storage subsystem 108 may include one or more storage units, such as multiple distributed storage units that are connected through a computer network. Each storage unit in the storage subsystem 108 may store at least one of one or more data assets and/or one or more data about the computed properties of one or more data assets. Moreover, each storage unit in the storage subsystem 108 may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

### Exemplary Predictive Data Analysis Computing Entity

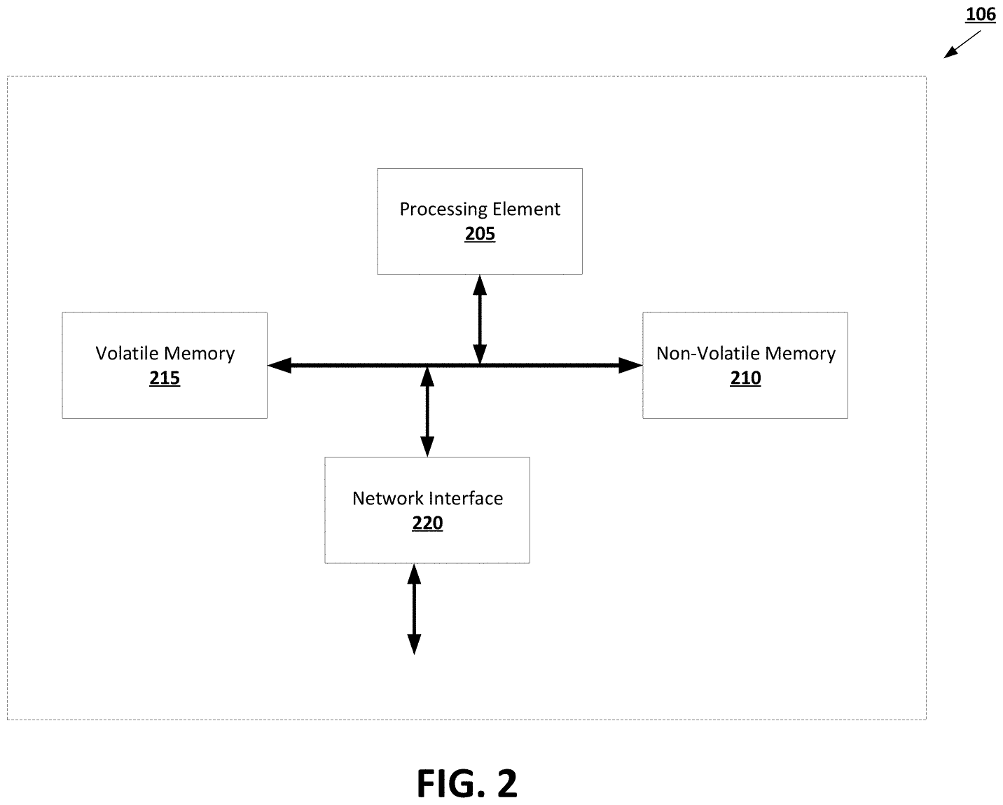

FIG. 2 provides a schematic of a predictive data analysis computing entity 106 according to one embodiment of the present invention. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the predictive data analysis computing entity 106 may also include one or more communications interfaces 220 for communicating with various computing entities, such as by communicating data, content, information, and/or similar terms used herein interchangeably that can be transmitted, received, operated on, processed, displayed, stored, and/or the like.

As shown in FIG. 2, in one embodiment, the predictive data analysis computing entity 106 may include, or be in communication with, one or more processing elements 205 (also referred to as processors, processing circuitry, and/or similar terms used herein interchangeably) that communicate with other elements within the predictive data analysis computing entity 106 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present invention when configured accordingly.

In one embodiment, the predictive data analysis computing entity 106 may further include, or be in communication with, non-volatile media (also referred to as non-volatile storage, memory, memory storage, memory circuitry and/or similar terms used herein interchangeably). In one embodiment, the non-volatile storage or memory may include one or more non-volatile storage or memory media 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the predictive data analysis computing entity 106 may further include, or be in communication with, volatile media (also referred to as volatile storage, memory, memory storage, memory circuitry and/or similar terms used herein interchangeably). In one embodiment, the volatile storage or memory may also include one or more volatile storage or memory media 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the predictive data analysis computing entity 106 with the assistance of the processing element 205 and operating system.

As indicated, in one embodiment, the predictive data analysis computing entity 106 may also include one or more communications interfaces 220 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the predictive data analysis computing entity 106 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the predictive data analysis computing entity 106 may include, or be in communication with, one or more input elements, such as a keyboard input, a mouse input, a touch screen/display input, motion input, movement input, audio input, pointing device input, joystick input, keypad input, and/or the like. The predictive data analysis computing entity 106 may also include, or be in communication with, one or more output elements (not shown), such as audio output, video output, screen/display output, motion output, movement output, and/or the like.

### Exemplary Client Computing Entity

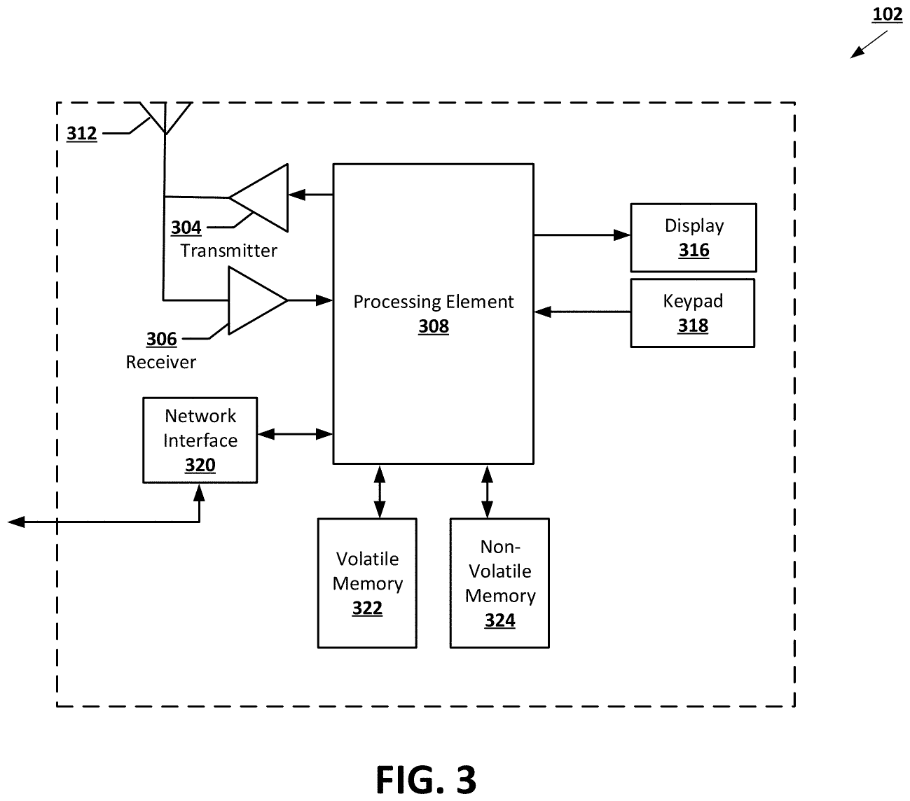

FIG. 3 provides an illustrative schematic representative of a client computing entity 102 that can be used in conjunction with embodiments of the present invention. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 can be operated by various parties. As shown in FIG. 3, the client computing entity 102 can include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the predictive data analysis computing entity 106. In a particular embodiment, the client computing entity 102 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the predictive data analysis computing entity 106 via a network interface 320.

Via these communication standards and protocols, the client computing entity 102 can communicate with various other entities using concepts such as Unstructured Supplementary Service Data (US SD), Short Message Service (SMS), Multimedia Messaging Service (MMS), Dual-Tone Multi-Frequency Signaling (DTMF), and/or Subscriber Identity Module Dialer (SIM dialer). The client computing entity 102 can also download changes, add-ons, and updates, for instance, to its firmware, software (e.g., including executable instructions, applications, program modules), and operating system.

According to one embodiment, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data can be determined by triangulating the client computing entity's 102 position in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The client computing entity 102 may also comprise a user interface (that can include a display 316 coupled to a processing element 308) and/or a user input interface (coupled to a processing element 308). For example, the user interface may be a user application, browser, user interface, and/or similar words used herein interchangeably executing on and/or accessible via the client computing entity 102 to interact with and/or cause display of information/data from the predictive data analysis computing entity 106, as described herein. The user input interface can comprise any of a number of devices or interfaces allowing the client computing entity 102 to receive data, such as a keypad 318 (hard or soft), a touch display, voice/speech or motion interfaces, or other input device. In embodiments including a keypad 318, the keypad 318 can include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The client computing entity 102 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the client computing entity 102. As indicated, this may include a user application that is resident on the entity or accessible through a browser or other user interface for communicating with the predictive data analysis computing entity 106 and/or various other computing entities.

In another embodiment, the client computing entity 102 may include one or more components or functionality that are the same or similar to those of the predictive data analysis computing entity 106, as described in greater detail above. As will be recognized, these architectures and descriptions are provided for exemplary purposes only and are not limiting to the various embodiments.

In various embodiments, the client computing entity 102 may be embodied as an artificial intelligence (AI) computing entity, such as an Amazon Echo, Amazon Echo Dot, Amazon Show, Google Home, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### V. Example System Operation

As described below, various embodiments of the present invention introduce techniques for improving operational reliability and computational efficiency of intervention recommendation predictive data analysis solutions by using a hierarchical intervention recommendation machine learning framework. As further described herein, a hierarchical intervention recommendation machine learning framework may limit real-time computational operations to those configured to generate an intermediate intervention score which is then used to perform one or more intermediate intervention operations, where executing final risk score determination operations is postponed until after executing one or more intermediate intervention operations. In this way, by utilizing these techniques, a predictive data analysis system can delay execution of some mission-critical operations to after a current time window, thus removing the number of real-time risk scoring operations that need to be performed. Accordingly, by using a hierarchical intervention recommendation machine learning framework, various embodiments of the present invention reduce the real-time operational load on intervention recommendation predictive data analysis solutions and thus improve operational reliability and computational efficiency of intervention recommendation predictive data analysis solutions.

As further described below, various embodiments of the present invention address technical challenges related to efficiently and effectively performing predictive data analysis. For example, various embodiments of the present invention disclose techniques for performing predictive data analysis operations utilizing a hierarchical intervention recommendation machine learning framework. For example, according to some embodiments of the present invention, predictive data analysis using a hierarchical intervention recommendation machine learning framework can be performed by: (i) generating a real-time risk score associated with a current prediction window using a real-time risk machine learning model of a hierarchical intervention recommendation machine learning framework, (ii) generating an intermediate risk score using an intermediate risk scoring machine learning model of the hierarchical intervention recommendation machine learning framework, (iii) generating an adjusted risk score using a risk aggregation machine learning model of the hierarchical intervention recommendation machine learning framework based at least in part on the real-time risk score and the intermediate risk score, and (iv) performing one more recommended prediction-based actions (e.g., intervention operations) based at least in part on the adjusted risk score.

At least one or more of the real-time risk scoring machine learning model, intermediate risk scoring machine learning model, and risk aggregation machine learning model of the hierarchical intervention recommendation machine learning framework utilizes training data and prediction operations that may, in at least some embodiments, reduce or eliminate the need for computationally expensive training operations in order to generate the respective risk scores, which in turn are used to perform predictive-based actions (e.g., one or more intermediate interventions and/or one or more final interventions). By reducing or eliminating the noted training operations, various embodiments of the present invention: (i) reduce or eliminate the computational operations needed for training and thus improves the computational efficiency of performing predictive data analysis, (ii) reduce or eliminate the need for storage resources to train/generate real-time risk scoring machine learning models, intermediate risk scoring machine learning models, and/or risk aggregation machine learning models for performing predictive data analysis, and thus improves storage efficiency of performing predictive data analysis, and (iii) reduce or eliminate the need for transmitting extensive training data needed to generate real-time risk scoring machine learning models, intermediate risk scoring machine learning models, and/or risk aggregation machine learning models for performing predictive data analysis and thus improves transmission/network efficiency of performing predictive data analysis. Via the noted advantages, various embodiments of the present invention make substantial technical contributions to the fields of predictive data analysis in particular and healthcare-related predictive data analysis in general.

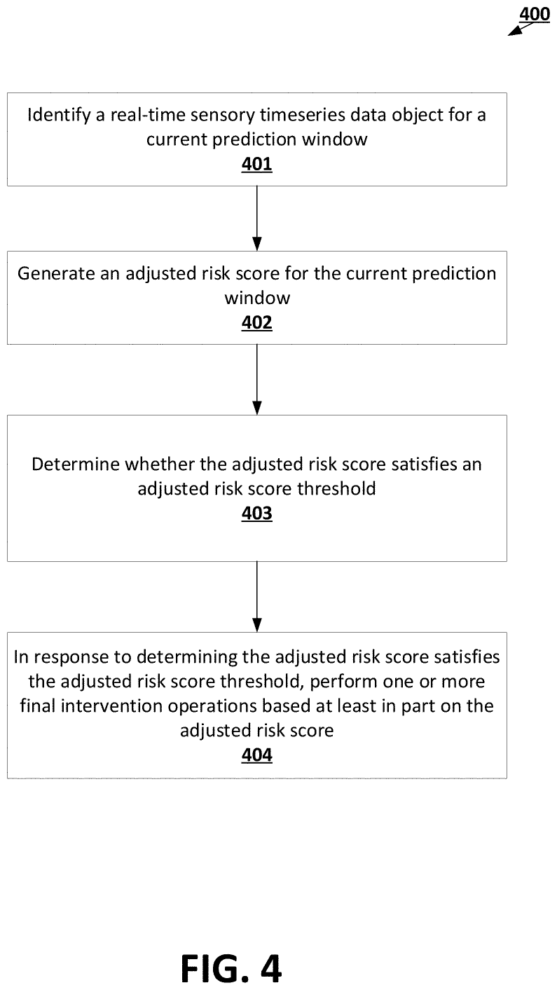

FIG. 4 is a flowchart diagram of an example process 400 for performing predictive data analysis operations using a hierarchical intervention recommendation machine learning framework. Via the various steps/operations of the process 400, a predictive data analysis computing entity 106 can utilize sensory data to effectively and efficiently generate risk scores, with respect to a monitored individual, for performing prediction-based actions. For example, in various embodiments, via the various steps/operations of the process 400, a predictive data analysis computing entity 106 can utilize sensory data to effectively and efficiently generate a set of risk scores for a monitored individual and perform one or more intervention operations based at least in part on the set of risk scores. Although, the following exemplary operations are described as being performed by the predictive data analysis computing entity 106, the client computing entity 102 may be configured to perform the operations. For example, the predictive data analysis computing entity 106 or the client computing entity 102 may be the primary computing entity. the Moreover, a portion of the operations may be performed by the predictive data analysis computing entity 106 and a portion of the operations may be performed by the client computing entity 102.

The process 400 that is depicted in FIG. 4 begins at step/operation 401 when the predictive data analysis computing entity 106 identifies a sensory data object associated with a current prediction window, where the sensory data object may describe recorded sensory measurements (also referred to as sensory data) captured (e.g., at intervals or continuously) by one or more sensors (also referred to as sensor devices). A current prediction window may describe a time period, with respect to which one or more prediction-based actions is determined for a monitored individual based at least in part on one or more risk scores associated with the time period. For example, in some embodiments, a current prediction window may describe a time period with respect to which one or more intervention recommendations is determined for a monitored individual based at least in part on one or more risk scores associated with the time period, where the one or more risk scores may be configured to be used to predict cognitive impairment. For example, in some embodiments, the one or more risk scores may be used to detect mild cognitive impairment. As another example, in some embodiments, the one or more risk scores may be used to detect the onset of mild cognitive impairment.

In some embodiments, the sensory data object is a real-time sensory timeseries data object associated with a current prediction window, where the current prediction window may describe a time period of a set of time periods across which a real-time sensory timeseries data object is calculated, which in turn may be used to determine appropriate prediction-based actions for a monitored individual. For example, in some embodiments, a set of real-time sensory time windows describes a set of defined time periods that follow each other in a continuous manner across which a real-time sensory timeseries data object is calculated. As another example, in some embodiments, a set of real-time sensory time windows describes a set of disjoint time periods across which a real-time sensory timeseries data object is calculated. As yet another example, in some embodiments, a set of real-time sensory time windows describes: (i) one or more sets of continuous time periods, where each set describes a set of defined time periods that follow each other in a continuous manner across which a real-time timeseries data object is calculated, and (ii) one or more sets of disjoint time periods, where each set describes a set of disjoint time periods across which a real-time sensory timeseries data object is calculated.

In some embodiments, the desired length of a period of time described by a current prediction window is determined based at least in part on predefined configuration data, where the predefined configuration data may in turn be determined prior to runtime using user-provided data (e.g., system administration data), using rule based models configured to determine optimal current prediction window lengths based at least in part on sensory data for the current prediction window, using machine learning models configured to determine optimal current prediction window length, and/or the like. In some embodiments, the desired length of a period of time described by a current prediction window is determined based at least in part on configurations that are dynamically generated at runtime using user-provided data (e.g., system administration data), using rule-based models configured to determine optimal current prediction window lengths based at least in part on sensory data for the current prediction window. Examples of optimal lengths for a period of time described by a current prediction window include twelve hours, one day, four days, two weeks, and/or the like.

As noted above a sensory data object (e.g., a real-time sensory timeseries data object) may describe one or more recorded sensory measurements. For example, in some embodiments, a real-time sensory timeseries data object describes recorded sensory measurements for a monitored individual over a set of time periods (e.g., current prediction window). In the noted embodiments, the real-time sensory timeseries data object may include recorded sensory measurements captured/measured at intervals (e.g., every 300 seconds, every five minutes, and/or the like).

Examples of recorded sensory measurements may include one or more recorded physiological condition measurements (e.g., body temperature, body alcohol level, pulse rate, heart rate, blood oxygen level, respiratory functions, sweat, blood pressure, and/or the like), one or more recorded behavioral condition measurements (e.g., eyelid movement, head tilt, eye blinking rate, arm movement, and/or the like), one or more recorded environmental condition measurements (e.g., weather condition, road condition, traffic light status, presence of a stop sign, road work sign, speed limit, moving object (e.g., vehicle) proximity with respect to other moving objects, and/or the like), one or more moving object (e.g., vehicle) operation condition measurements (e.g., rate of acceleration, rate of deceleration, steering wheel operation, and/or the like). In some embodiments, a real-time sensory timeseries data object may describe one or more recorded physiological conditions, one or more recorded behavioral conditions, one or more recorded environmental condition measurements, and/or one or more recorded moving object (e.g., vehicle) operation condition measurements. In some embodiments, at least a portion of the recorded measurements are associated with a timestamp.

In some embodiments, the data described by the real-time sensory timeseries data object is determined using one or more sensors (e.g., sensor devices) that are configured to capture (e.g., periodically or continuously) over time, one or more sensory measurements (e.g., physiological condition measurement, behavioral condition measurements, environmental condition measurements, moving object operation condition measurements, and/or the like) associated with the monitored individual and provide/transmit the noted sensory measurements to the predictive data analysis computing entity 106 and/or client computing entity 102, where the predictive data analysis computing entity 106 and/or client computing entity 102 may be configured to generate the real-time sensory timeseries data object based at least in part on the one or more sensory measurements. In the noted embodiments, a real-time sensory timeseries data object may be characterized by sensory data (e.g., sensory measurements) for S sensors during a current prediction window/current time window, where each per-sensor sensory data may itself be a combination of one or more sensory measurements across one or more timestamps of the current prediction window/current time window.

In some embodiments, at least a portion of the sensor devices may be in-vehicle sensors, where in-vehicle sensors describe sensors (also referred to as sensor devices) that are located in/on/within a moving object (e.g., vehicle) operated by a monitored individual. In example embodiments, at least a portion of the sensor devices may be connected to various locations within the moving object/vehicle. Examples of in-vehicle sensors include body temperature sensors and/or infra-red (IR) temperature sensors for obtaining body temperature measurements; cameras and/or infra-red (IR) cameras for obtaining eyelid movement measurements, cameras and/or infra-red (IR) cameras for monitoring external conditions/environmental conditions, such as traffic light signals, and/or the like; alcohol sensors for obtaining blood alcohol measurements; vehicle brake sensors for capturing data configured for obtaining attentiveness measurements with respect to a monitored individual; vehicle accelerator sensors for capturing data configured for obtaining attentiveness measurements with respect to a monitored individual; pulse rate sensors for obtaining pulse rate measurements; heart rate sensors for obtaining heart rate measurements; blood oxygen sensors for obtaining blood oxygen level measurements; breathing pattern sensors for obtaining breathing pattern measurements; skin conductance sensors for obtaining sweat measurements; and/or the like.

In some embodiments, the predictive data analysis computing entity 106 may receive a portion of the sensory data/measurements from sensor devices associated with a smartphone device. Examples of sensory measurements that may be obtained from smartphone device sensors include, eye movement measurements, heart rate measurements, pulse rate measurements, facial feature measurements, and/or the like. As another example, the predictive data analysis computing entity 106 may receive a portion of the sensory data from medical sensor devices connected to various locations within the physiological anatomy of the monitored individual. Examples of noted medical sensor devices include chest straps, heart-rate detectors, blood pressure detectors, and/or the like. As yet another example, the predictive data analysis computing entity 106 may receive a portion of the sensory data from medical sensor devices associated with a smart watch device. As a further example, the predictive data analysis computing entity 106 may receive a portion of the sensory data from medical sensor devices associated with a personal assistant device.

At step/operation 402, the predictive data analysis computing entity 106 generates an adjusted risk score for the current prediction window. An adjusted risk score may describe a risk score that is configured to be used to detect/predict one or more (or onset of one or more) conditions with respect to a monitored individual and determine appropriate prediction-based actions. For example, in some embodiments, an adjusted risk score may describe a risk score that is used to detect whether a corresponding monitored individual is experiencing cognitive impairment. Additionally and/or alternatively, in some embodiments, an adjusted risk score may be used to determine one or more intervention recommendations based at least in part on whether the adjusted risk score satisfies a defined threshold (e.g., less than, equal to, and/or above). For example, a particular adjusted risk score may describe that a corresponding monitored individual is experiencing cognitive impairment. As another example, a particular adjusted risk score may describe that a corresponding monitored individual is experiencing the onset of a cognitive impairment. As yet another example, a particular adjusted risk score may describe that a corresponding monitored individual is not experiencing cognitive impairment. As a further example, a particular adjusted risk score may describe that a corresponding monitored individual is not experiencing the onset of cognitive impairment.

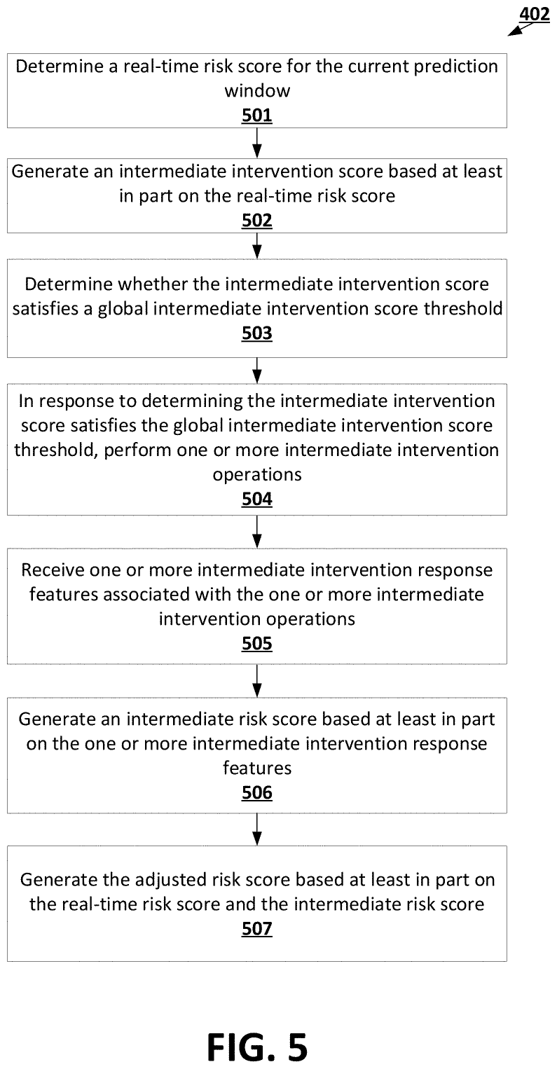

In some embodiments, an adjusted risk score is generated by a risk aggregation machine learning model by processing a set of risk scores associated with the corresponding monitored individual. For example, the adjusted risk score may be generated by processing (using a risk aggregation machine learning model) the real-time risk score for the current prediction window and an intermediate risk score (further described below) associated with the current prediction window. In the noted embodiments, the real-time risk score and the intermediate risk score may be input variables for the risk aggregation machine learning model. In some embodiments, the step/operation 402 may be performed in accordance with the process 500 that is depicted in FIG. 5, which is an example process for generating an adjusted risk score. The process 500 begins at step/operation 501 when the predictive data analysis computing entity 106 determines a real-time risk score for a current prediction window for a given monitored individual. A real-time risk score may describe a risk score for a current prediction window for a given monitored individual, that is generated in real time (e.g., near real time) and is in turn configured to be used to determine an intermediate risk score and an adjusted risk score for the monitored individual, where the real-time risk score may be describe the severity level of a condition (e.g., cognitive impairment) with respect to the monitored individual. In some embodiments, the real-time risk score is generated using a real-time risk scoring machine learning model (e.g., moving average threshold model) of the hierarchical intervention recommendation machine learning framework.

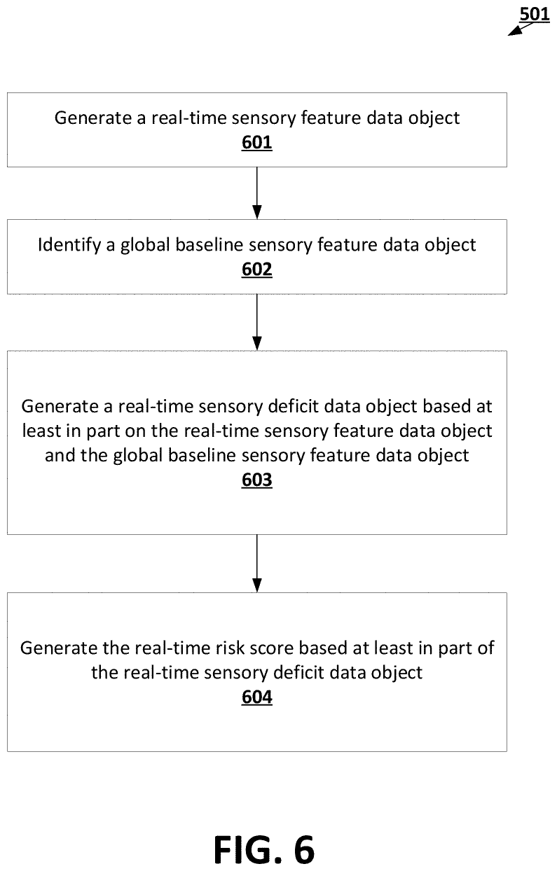

In some embodiments, the step/operation 501 may be performed in accordance with the process depicted in FIG. 6, which is an example process for determining a real-time risk score for a current prediction window for a monitored individual. The process that is depicted in FIG. 6 begins at step/operation 601 when the predictive data analysis computing entity 106 generates a real-time sensory feature data object. A real-time sensory feature data object may describe one or more real-time sensory features associated with a current prediction window, where a real-time sensory feature value may describe the performance (e.g., driving behavior) of a monitored individual during the current prediction window with respect to a corresponding real-time sensory feature. In some embodiments, a real-time sensory feature value may (alone or in combination with one or more other sensory feature value) indicate the likelihood of potential cognitive impairment.

In the some embodiments, examples of real-time sensory features may include a reaction time sensory feature that describes reaction time (e.g., response time) of a monitored individual with respect to an event (e.g., how long it takes a monitored individual to apply the brakes in response to a traffic light signal changing to red, how long it takes a monitored individual to cause the associated vehicle to move in response to a traffic light signal changing to green, and/or the like), braking pattern sensory feature that describes observed braking patterns with respect to a moving object (e.g., vehicle) operated by the monitored individual, alertness sensory feature that describes alertness/attentiveness of a monitored individual, motion pattern sensory features such as lane change pattern, speed/acceleration pattern, and/or the like with respect to a moving object operated by a monitored individual, and/or the like.

In some embodiments, the real-time sensory feature data object is determined based at least in part on the real-time sensory timeseries data object associated with the current prediction window. In some embodiments, a real-time sensory feature may be determined based at least in part on one or more recorded sensory measurements associated with the real-time sensory timeseries data object. For example, in some embodiments, a particular real-time sensory feature for may be determined based at least in part on sensory measurements of a subset of sensors. For example, in the noted embodiments, the real-time sensory feature data object may comprise a per-sensor-subset real-time sensory feature for each sensor subset of one or more sensor subsets. A sensor subset may describe a group of sensors that are used to determine a real-time sensory feature. For example, a particular sensor subset may include (i) an in-vehicle camera sensor configured for monitoring traffic light signals and capturing when a traffic light signal turns red along with the corresponding timestamp, and (ii) an in-vehicle braking sensor for capturing when a monitored individual operating (e.g., driving) a vehicle begins to engage/apply the brakes along with the corresponding timestamp. In the noted example, the predictive data analysis computing entity 106 may be configured to correlate the respective camera sensor timestamp and the braking sensor timestamp to determine a reaction time sensory feature that describes the reaction time of the monitored individual with respect to the traffic light signal turning red.

In some embodiments, a particular real-time sensory feature may be determined based at least in part on sensory measurements of a particular sensor. For example, in some embodiments, the real-time sensory feature data object may comprise a per-sensor real-time sensory feature for each sensor of the one or more sensors associated with the real-time sensory timeseries data object. For example, a particular real-time sensory feature may be determined based at least in part on recorded measurements of a single sensor. For example, the predictive data analysis computing entity 106 may determine attentiveness sensory feature utilizing a camera configured to monitored pupil movements of a corresponding monitored individual. In some embodiments, the real-time sensory feature data object may comprise one or more per-sensor-subset real-time sensory feature and/or one or more per sensor real-time sensory feature.

In some embodiments, to generate the real-time sensory feature data object, the predictive data analysis computing entity 106 utilizes one or more processing/analysis engines of the predictive data analysis computing entity 106 to process/analyze the real-time sensory data object (e.g., real-time sensory timeseries data object) to determine real-time sensory feature value associated with the real-time sensory feature data object. For example, in some embodiments a first processing/analysis engine of the predictive data analysis computing entity 106 may be configured to process/analyze at least a portion of the real-time sensory timeseries data object. For example, in some embodiments, the first processing/analysis engine may be configured to process/analyze the environmental condition sensory measurements and/or the moving object operation sensory measurements. Additionally, in some embodiments, the first processing/analysis engine may be configured for capturing one or more sensory data (e.g., environmental condition sensory measurements, moving object operation sensory measurements, and/or the like) associated with the real-time sensory timeseries data object utilizing the corresponding sensor devices.

In some example embodiments, a second processing/analysis engine of the predictive data analysis computing entity 106 may be configured to process/analyze a portion of the real-time sensory timeseries data object. For example, in some embodiments, the second processing/analysis engine may be configured to process/analyze the physiological condition sensory measurements and/or the behavioral condition sensory measurements. Additionally, in some embodiments, the second processing/analysis engine may be configured for capturing one or more sensory data (e.g., physiological condition sensory measurements, behavioral sensory measurements, and/or the like) associated with the real-time sensory timeseries data object utilizing corresponding sensors. In some embodiments, the second processing/analysis engine of the predictive data analysis computing entity 106 with the assistance of the first processing/analysis engine may be configured to determine the one or more real-time sensory features associated with the real-time sensory feature data object. For example, in some embodiments, the second processing/analysis engine of the predictive data analysis computing entity 106 with the assistance of the first processing/analysis engine may be configured to determine abnormal driving behavior with respect to the monitored individual based at least in part on recorded observations (e.g., real time sensory features) such as (i) whether or not the reaction time for the monitored individual to apply the brakes of the vehicle being driven by the monitored individual had degraded when compared to historic data; (ii) whether the monitored individual (e.g., driver) has been making incorrect turns (e.g., taking a wrong turn frequently may indicate potential confusion); (iii) whether the outside road conditions have been determined as favorable (e.g., no vehicle or interruptions in sight) and the conditions deemed good to maintain the current speed (or even increase the speed further), but the driver had momentarily decelerated by applying the brakes and the pupil movement did not indicate any drowsiness, and/or the like. In some embodiments, the real-time sensory feature data object may be an n sized vector comprising n real-time sensory features, where n may be one, five, and/or the like. In some embodiments, the predictive data analysis computing entity 106 utilizes only one processing/analysis engine to process/analyze the real-time sensory data object (e.g., real-time sensory timeseries data object) to determine real-time sensory feature value associated with the real-time sensory feature data object.

At step/operation 602, the predictive data analysis computing entity 106 identifies a global baseline sensory feature data object. A global baseline sensory feature data object may describe one or more global thresholds corresponding to a real-time sensory feature associated with the real-time sensory feature data object. For example, a particular global threshold may correspond to a particular real-time sensory feature while another particular global threshold may correspond to another (e.g., different) particular real-time sensory feature. For example, a particular global threshold may correspond to a reaction time sensory feature, while another particular global threshold may correspond to braking pattern sensory feature. A given global threshold may be a moving average. For example, a particular global threshold corresponding to a given real-time sensory feature may be different for two different current prediction windows. For example, the global threshold corresponding to a reaction time sensory feature may be X for a first current prediction window and Y for a second current prediction window. In some embodiments, the global baseline sensory feature data object may be utilized by the predictive data analysis computing entity 106 to perform an evaluation for an evaluation period (e.g., current prediction window). For example, in some embodiments, the predictive data analysis computing entity 106 may be configured to compare each real-time sensory feature associated with a real-time sensory feature data object with the corresponding global threshold using an arithmetic ensemble (e.g., difference between a real-time sensory feature value and corresponding global threshold). Consider for example, where a real-time sensory feature data object comprises a reaction time sensory feature, a braking pattern sensory feature, and alertness sensory feature. In the noted example, the global baseline sensory feature data object will likewise include a reaction time global threshold, a braking pattern global threshold, and alertness global threshold.

In some embodiments, the predictive data analysis computing entity 106 may be a particular client computing entity, and a server computing entity may be configured to periodically provide global thresholds to the particular client computing entity. In the noted embodiment, the particular client computing entity (e.g., predictive data analysis computing entity 106) may be configured to transmit associated real-time sensory feature values to the server computing entity.

In some embodiments, the predictive data analysis computing entity 106 may be a server computing entity and may be configured to generate global thresholds and retrieve the generated global thresholds. In some embodiments, the server computing entity is configured to generate optimal global thresholds based at least in part on: (i) a statistical distribution measure of sensory feature values associated with a plurality of client computing entities associated with the server computing entity, and (ii) historical real-time sensory feature values associated with the particular client computing entity. In some embodiments, each client computing entity of the plurality of client computing entities is associated with an individual of a similarly situated population with respect to the monitored individual and the current prediction window, where a similarly situated population may describe a population of drivers (e.g., plurality of individuals) going through (and/or that have gone through) similar driving scenarios/conditions as the monitored individual. In some embodiments, generating a statistical distribution measure of sensory feature values may include aggregating sensory feature values associated with the plurality of client computing entities associated with the similarly situated population.

In some embodiments, the global baseline sensory feature data object may include a per-sensor baseline sensory feature for each sensor of the one or more sensors, where each per-sensor baseline sensory feature corresponds to a per-sensor real-time sensory feature associated with the real-time sensory feature data object. In some embodiments, the global baseline sensory feature data object may include a per-sensor-subset baseline sensory feature for each sensor-subset of one or more sensor subsets, where each per-sensor-subset baseline sensory feature corresponds to a per sensor-subset real time sensory feature associated with the real-time sensory feature data object. In some embodiments, the global baseline sensory feature data object may include one or more per-sensor baseline sensory features and/or one or more per-sensor-subset baseline sensory features. In some embodiments, the global baseline sensory feature data object may be an n sized vector comprising n global thresholds, where n may be one, five, and/or the like.

At step/operation 603, the predictive data analysis computing entity 106 generates a real-time sensory deficit data object based at least in part on the real-time sensory feature data object and the global baseline sensory feature data object. A real-time sensory deficit data object may describe a measure that is configured to be used to determine a real-time risk score for a current prediction window. In some embodiments, the real-time sensory deficit data object indicates whether there is a detrimental change in the monitored individual's condition. In some embodiments, the real-time sensory deficit data object comprises a per-sensory real-time sensory deficit value for each sensor-subset of the one or more sensor-subsets. In some embodiments, the real-time sensory deficit data object comprises a per-sensory real-time sensory deficit value for each sensor of the one or more sensors.

In some embodiments, generating the real-time sensory deficit data object comprises, for each sensor-subset, determining the per-sensory real-time sensory deficit value based at least in part on the per-sensor-subset real-time sensory feature for the sensor-subset and the per-sensor-subset baseline sensory feature for the sensor-subset. In some embodiments, generating the real-time sensory deficit data object comprises, for each sensor, determining the per-sensory real-time sensory deficit value based at least in part on the per-sensor real-time sensory feature for the sensor and the per-sensor baseline sensory feature for the sensor. In some embodiments, the real-time sensory deficit data object may be an n sized vector, where n may be one, five, and/or the like. In some embodiments, the real-time sensory deficit data object may comprise an arithmetic ensemble model of the real-time sensory feature data object and the global baseline sensory feature data object. In example embodiments, determining the real-time sensory deficit data object includes performing the operation described by the below equation:

D=(Th^{global}−P^{local}) Equation 1

In equation 1:
D is the real-time sensory deficit data object,
Th^{global} is the global baseline sensory data object, and
P^{local} is the real-time sensory feature data object.

In the noted example embodiment, the real-time sensory deficit data object may be indicative of the severity of cognitive impairment with respect to the corresponding monitored individual. As further described below, a decreasing deficit data object trend (for example, where P^{local} gradually approaches Th^{global}) may be indicative of increasing cognitive impairment severity (e.g., gradual worsening of mild cognitive impairment). Moreover, in the noted example embodiment, a negative real-time sensory deficit data object (for example, where P^{local} greater than Th^{global}) may be indicative of the effect of one or more external factors (not indicative of cognitive impairment). Examples of the one or more external factors may include high blood alcohol level, medication effects, concussion, and/or the like.

At step/operation 604, the predictive data analysis computing entity 106 generates the real-time risk score based at least in part on the real-time sensory deficit data object (e.g., based at least in part on the real-time sensory feature data object and the global baseline sensory data object). For example, is some embodiments, generating the real-time risk score comprises generating the real-time risk score based at least in part on each per-sensor baseline sensory feature.

In some embodiments determining the real-time risk score may include performing the operation described by the below equation:

$${M}_{1} = \frac{1}{{( {Th}^{global} - {P}^{local} )}_{w} + ϵ} \qquad Equation 2$$

In equation 2:
M₁ is the real-time risk score,
Th^{global} is the global baseline sensory data object, and
P^{local} is the real time sensory feature data object,
w is the predefined historic window (e.g., moving average window size w) with respect to which each of Th^{global} and P^{local} is calculated, and
ε is a normalizing value.

As noted above, in some embodiments, the real-time risk score (M₁) may describe a cognitive impairment severity with respect to the corresponding monitored individual. For example, a higher M₁ value may describe a more severe cognitive impairment condition. Moreover, increasing M₁ values (e.g., decreasing real-time sensory deficit data object) associated with a corresponding monitored individual may describe gradual worsening of cognitive impairment with respect to the monitored individual. In some embodiments, a current prediction window may be associated with one or more historical prediction windows, where each historical prediction window may describe a previous current prediction window with respect to the monitored individual. Each historical prediction window associated with the current historical prediction window may be associated with a historical risk score, where an historical risk score describes a previous real-time risk score (e.g. previous M₁ value) associated with a previous current prediction window. For example, in some embodiments, the current prediction window is associated with N historical prediction windows, where each historical prediction window is associated with a historical risk score, and where N may be one, ten, and/or the like.

As an example, consider where a given monitored individual is associated with the following current prediction window and historical prediction windows:
Day 1—P^{local}=0.2; Th^{global}=0.8; ε=0.0000001; M₁=1.66
Day 20—P^{local}=0.5; Th^{global}=0.8; ε=0.0000001; M₁=3.33
Day 35—P^{local}=0.7; Th^{global}=0.8; ε=0.0000001; M₁=9.99

Where Day 35 is the current prediction window associated with a current real-time risk score (e.g., current M₁ score) and Day 1 and Day 20 are historical prediction windows associated with historical risk scores (e.g., previous M₁ scores). In the noted example, the increasing M₁ scores may indicate gradual worsening of cognitive impairment with respect to the monitored individual.

In some embodiments, a sudden change of M₁ from a positive value to a negative value (e.g., where P^{local} is greater than Th^{global}, as described above) may indicate the effect of one or more external factors (e.g., high blood alcohol level, medication effects, concussion, and/or the like) and not indicative of cognitive impairment. As an example, consider where a given monitored individual is associated with the following current prediction window and historical prediction windows:
Day 1—P^{local}=0.1; Th^{global}=0.8; ε=0.0000001; M₁=1.42
Day 25—P^{local}=0.11; Th^{global}=0.8; ε=0.0000001; M₁=1.44
Day 26—P^{local}=1.5; Th^{global}=0.8; ε=0.0000001; M₁=−1.42

Where Day 26 is the current prediction window associated with a current real-time risk score (e.g., current M₁ score) and Day 1 and Day 25 are historical prediction windows associated with historical risk scores (e.g., previous M₁ scores). In the noted example, the sudden shift of M₁ from a positive value to a negative value may indicate the effect of one or more external factors, and not indicative of cognitive impairment.

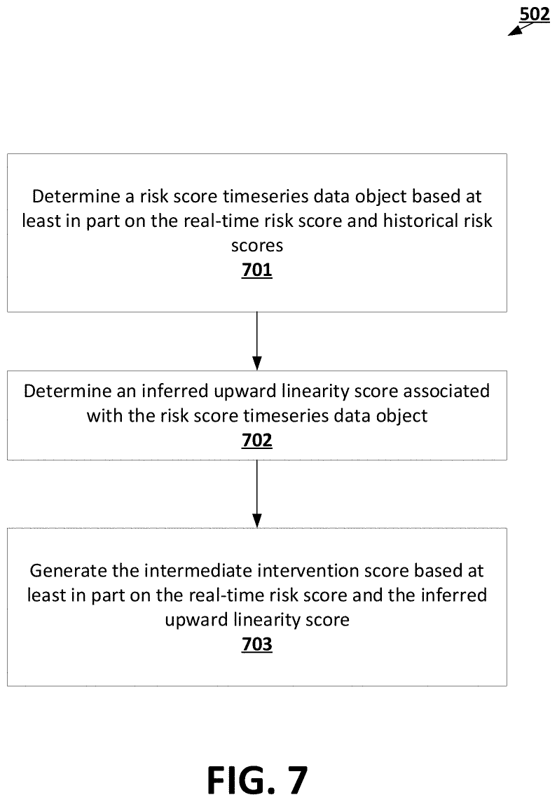

Returning to FIG. 5 at step/operation 502, the predictive data analysis computing entity 106 generates an intermediate intervention score based at least in part on the real-time risk score calculated for the current prediction window. An intermediate intervention score may describe a measure that is configured to determine an intermediate intervention need, where an intermediate intervention need describes a determination whether to perform an intermediate intervention operation or not to perform an intermediate intervention operation (further described below). In some embodiments, the step/operation 502 may be performed in accordance with the process 700 that is depicted in FIG. 7, which is an example process for generating an intermediate intervention score with respect to a current prediction window.

The process that is depicted in FIG. 7 begins at step/operation 701 when the predictive data analysis computing entity 106 determines a real-time risk score timeseries data object based at least in part on the real-time risk score for the current prediction window and one or more historical risk scores associated with a corresponding historical prediction window associated with the current prediction window. For example, in some embodiments, the predictive data analysis computing entity 106 determines a real-time risk score timeseries data object based at least in part on the real-time risk score for the current predictive window and each historical risk score associated with a corresponding historical prediction window associated with the current prediction window.

In some embodiments, the real-time risk score timeseries data object comprises a real-time risk score for the current prediction window and one or more historical risk scores associated with corresponding historical prediction windows associated with the current prediction window over a set of time periods, where the set of time periods follow each other in a continuous manner (e.g., based at least in part on associated timestamps). For example, each historical risk score of the one or more historical risk scores and the real-time risk score for the current prediction window may be ordered based at least in part on associated timestamps, where for example, a historical risk score, associated with an earlier timestamp precedes a historical risk score associated with a later timestamp, and all historical risk scores precede the real-time risk score for the current prediction window.

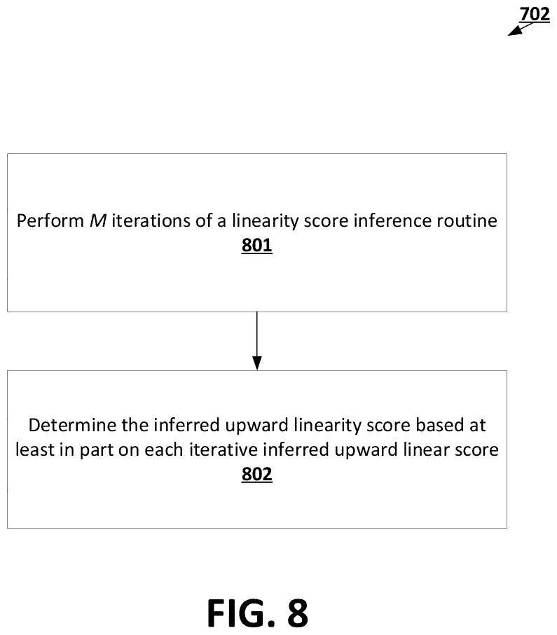

At step/operation 702, the predictive data analysis computing entity 106 determines an inferred upward linearity score associated with the real-time risk score timeseries data object, where an inferred upward linearity score may describe how much the real-time risk score timeseries data object increases linearly. In some embodiments, the step/operation 702 may be performed in accordance with the process 800 that is depicted in FIG. 8, which is an example process for determining an inferred upward linearity score associated with a real-time risk score timeseries data object. As noted above, in some embodiments, the current prediction window may be associated with N historical prediction windows, where each historical prediction window is associated with a historical risk score, and where N may be one, ten, and/or the like. The process 800 that is depicted in FIG. 8 begins at step/operation 801 when the predictive data analysis computing entity 106 performs M iterations of a linearity score inference routine, where M≤N. In some embodiments, each iteration includes: (i) determining an iteratively enlarged subset of the risk score timeseries data object that is associated with the real-time risk score and most recent m historical risk scores, where m is initially set to one and incremented at the end of each iteration, and (ii) determining an iterative inferred upward linear score based at least in part on the iteratively enlarged subset and a linear trend data object for the iteratively enlarged subset.

At step/operation 802, the predictive data analysis computing entity 106 determines the inferred upward linearity score based at least in part on each iterative inferred upward linear score. Returning to FIG. 7 at step/operation 703, the predictive data analysis computing entity 106 generates the intermediate intervention score based at least in part on the real-time risk score and the inferred upward linearity score.

Returning to FIG. 5 at step/operation 503, the predictive data analysis computing entity 106 determines an intermediate intervention need, where, as noted above, an intermediate intervention need describes a determination whether to perform an intermediate intervention operation or not to perform an intermediate intervention operation. In some embodiments, determining an intermediate intervention need includes determining whether an intermediate intervention score satisfies an intermediate intervention score threshold (e.g., a global intermediate intervention score threshold). For example, in some embodiments, the predictive data analysis computing entity 106 compares an intermediate intervention score to a global intermediate intervention score threshold and determines whether to perform an intermediate operation based at least in part on the result of the comparison.

In some embodiments, the predictive data analysis computing entity 106 is a particular client computing entity, and a server computing entity is configured to periodically provide global intermediate intervention score thresholds to the particular client computing entity. In some embodiments, the server computing entity is configured to generate an optimal global intermediate intervention score threshold based at least in part on: (i) a statistical distribution measure of sensory data associated with a plurality of client computing entities associated with the server computing entity, and (ii) historical sensory data associated with the particular client computing entity.

In some embodiments, the predictive data analysis computing entity 106 is a server computing entity, and is configured to provide the global intermediate intervention score thresholds, where providing the global intermediate intervention score thresholds comprises generating the global intermediate intervention score thresholds and retrieving the generated global intermediate intervention score thresholds.

At step/operation 504, in response to determining that the intermediate intervention score satisfies the global intermediate intervention score threshold, the predictive data analysis computing entity 106 performs one or more intermediate intervention operations. An intermediate intervention operation may describe one or more tests (e.g., challenges) presented to the corresponding monitored individual, where the one or more tests is configured to assess/evaluate the cognitive state of the monitored individual. In some embodiments, the response to the one or more tests may be used to determine the onset of mild cognitive impairment. In some embodiments, the predictive data analysis computing entity 106 does not begin to perform the one or more intermediate intervention operations until the moving object (e.g., vehicle) operated by the monitored individual is stationary (e.g., parked).

In some embodiments, in response to determining that the intermediate intervention score satisfies the global intermediate intervention score threshold, the predictive data analysis computing entity 106 presents (e.g., displays via a user interface associated with the monitored individual) one or more of: (i) a reaction time test (RTI); (ii) a motor screening test (MOT); and (iii) a modified paired associates learning test (PAL). As noted above, in some embodiments, the predictive data analysis computing entity presents the one or more tests only after the associated vehicle is stationary (e.g., parked). In some embodiments, the predictive data analysis computing entity 106 leverages head-up displays (HUD), center console screens, and/or the like located in the vehicle operated by the monitored individual. For example, in the noted embodiments, the predictive data analysis computing entity displays the one or more tests (e.g., RTI, MOT, PAL, and/or the like) on a user interface associated with an head-up display, center console screen, and/or the like in the vehicle operated by the monitored individual.

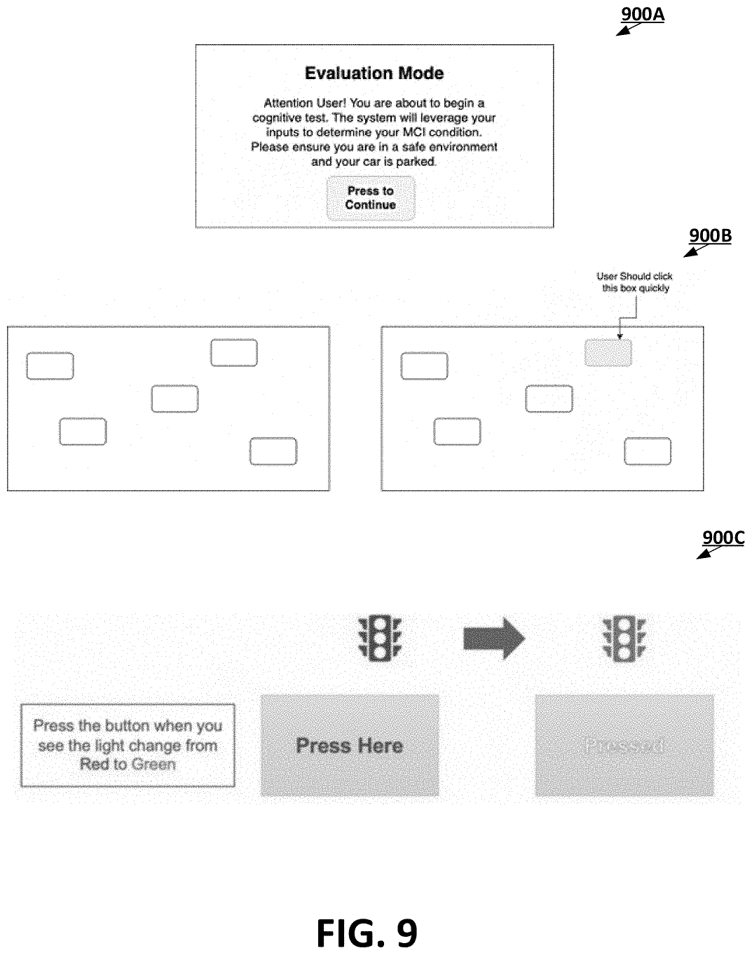

FIG. 9, depicts operational examples 900A-C of a reaction time test. As depicted in 900A of FIG. 9, the predictive data analysis computing entity 106 displays on a user interface associated with a client computing entity associated with the monitored individual a test notification notifying the monitored individual that a test is about to commence (e.g., start), along with one or more instructions associated with the test. As depicted in 900B of FIG. 9, the predictive data analysis computing entity 106 displays a random pattern of boxes distributed across the display screen of the user-interface associated with the monitored individual, where one or more boxes is configured to change its color. In some embodiments, the random pattern of boxes is configured to change each time the test is conducted to avoid memorization effects.

The predictive data analysis computing entity 106 then transmits one or more instruction notifications to the monitored individual (e.g., via a client computing entity associated with the monitored individual), where the one or more instruction notifications may include instructions to select the box that changes color. The predictive data analysis computing entity 106 may be configured to perform one or more iterations. For example, in some embodiments, in response to the monitored individual's response, the predictive data analysis computing entity 106 may be configured to transmit another instruction notification to the monitored individual (e.g., via a client computing entity associated with the monitored individual) instructing the monitored individual to once again select the box that changes color. In some embodiments, the predictive data analysis computing entity 106 may automatically re-display the random pattern of boxes. In some embodiments, the number of iterations may be a predefined value (e.g., five iterations, and/or the like). In some embodiments, the number of iterations may be based at least in part on the monitored individual's response. For example, the predictive data analysis computing entity 106 may transmit an instruction notification corresponding to an iteration up to a defined maximum predefined number of iterations. For example, the predictive data analysis computing entity 106 may be configured to stop the reaction time test (e.g., stop sending instruction notifications) in response to a correct response from the monitored individual.

In some embodiments, the predictive data analysis computing entity 106 may record (e.g., store) the reaction time to select the correct box (e.g., box that changes its color) along with the number of incorrect selections. The predictive data analysis computing entity 106 may then generate one or more RTI reaction time deficit data objects. In some embodiments, the predictive data analysis computing entity 106 generates a first RTI reaction time deficit data object based at least in part on comparing the reaction time with historical reaction times for the monitored individual. Additionally, the predictive data analysis computing entity 106 generates a second RTI reaction time deficit data object based at least in part on comparing the reaction time with a global RTI reaction time data object, where the global RTI reaction time data object may describe the performance (e.g., reaction time) of a cluster of known population (e.g., individuals) with mild cognitive impairment. In some embodiments, first reaction time deficit data object and/or the second reaction time deficit data object are input variables to a machine learning model (e.g., an intermediate risk scoring machine learning model).

As depicted in 900C of FIG. 9, the reaction time test may include displaying on a user interface associated with a client computing entity associated with the monitored individual, a traffic light signal and a box, and transmitting a notification to the monitored individual (e.g., via a client computing entity associated with the monitored individual) providing instructions to select the box when the traffic light signal changes color (e.g., from red to green, green to red, or the like). The predictive data analysis computing entity 106 records (e.g., store) the reaction time to select the box. The predictive data analysis computing entity 106 may then generate one or more RTI reaction time deficit data objects based at least in part on the reaction time as discussed above in relation to operational example 900B of FIG. 9.

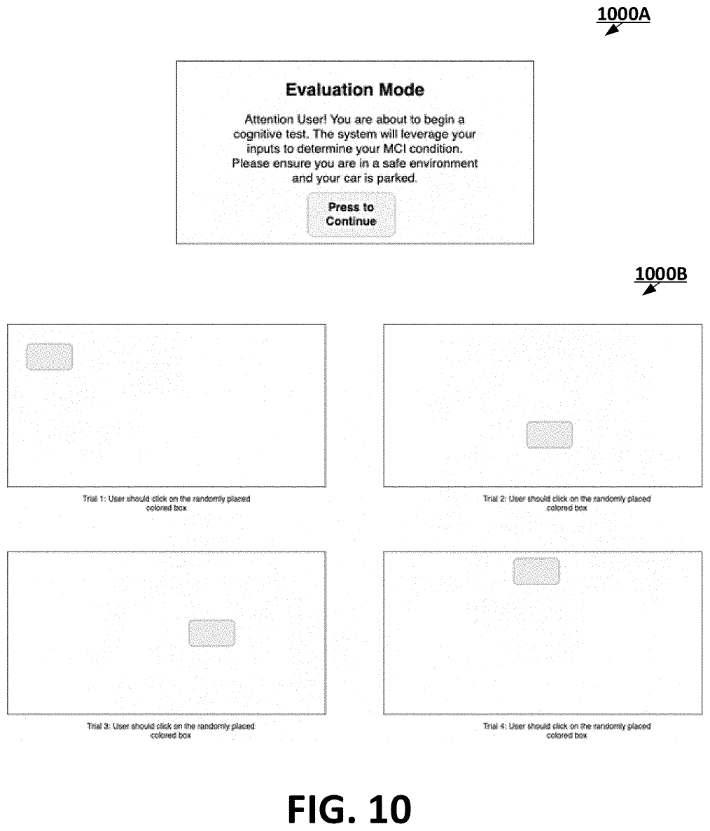

FIG. 10 depicts operational examples 1000A-B of a motor screening test. As depicted in 1000A, the predictive data analysis computing entity 106 may display on a user interface associated with a client computing entity associated with the monitored individual a test notification notifying the monitored individual that a test is about to commence (e.g., start), along with instructions associated with the test. As depicted in 1000B, the predictive data analysis computing entity 106 displays a box at a random position on the user-interface and transmits an instruction notification to the monitored individual (e.g. via a client computing entity associated with the monitored individual) providing instructions to select the box as quickly as possible. In example embodiments, the predictive data analysis computing entity 106 may be configured to perform one or more iterations. In the noted example embodiment, for each iteration, the predictive data analysis computing entity 106 may be configured to change the position (e.g., location) of the box on the display of the user-interface. In some embodiments, the predictive data analysis computing entity 106 may be configured to perform a predefined number of iterations (e.g., five iterations, and/or the like). In some embodiments, the number of iterations may be based at least in part on the monitored individual's response. For example, the predictive data analysis computing entity 106 may display a box at a random position for up to a defined maximum number of iterations and may be configured to stop the test when it is determined that the monitored individual selected the box at a reaction time that satisfies a defined threshold (e.g., less than, equal to, and/or above).

In some embodiments, the predictive data analysis computing entity 106 may record (e.g., store) the reaction time to select the box. The predictive data analysis computing entity 106 may then generate one or more MOT reaction time deficits. In some embodiments, the predictive data analysis computing entity 106 generates a first MOT reaction time deficit data object based at least in part on comparing the reaction time with historical reaction times (e.g., results of previous motor screening tests) for the monitored individual. Additionally, the predictive data analysis computing entity 106 generates a second MOT reaction time deficit data object based at least in part on comparing the reaction time with a global MOT reaction time data object, where the global MOT reaction time data object may describe the performance (e.g., reaction time) of a cluster of known population (e.g., individuals) with mild cognitive impairment. In some embodiments, the first MOT reaction time deficit data object and/or the second MOT reaction time deficit data object are input variables to a machine learning model (e.g., an intermediate risk scoring machine learning model).

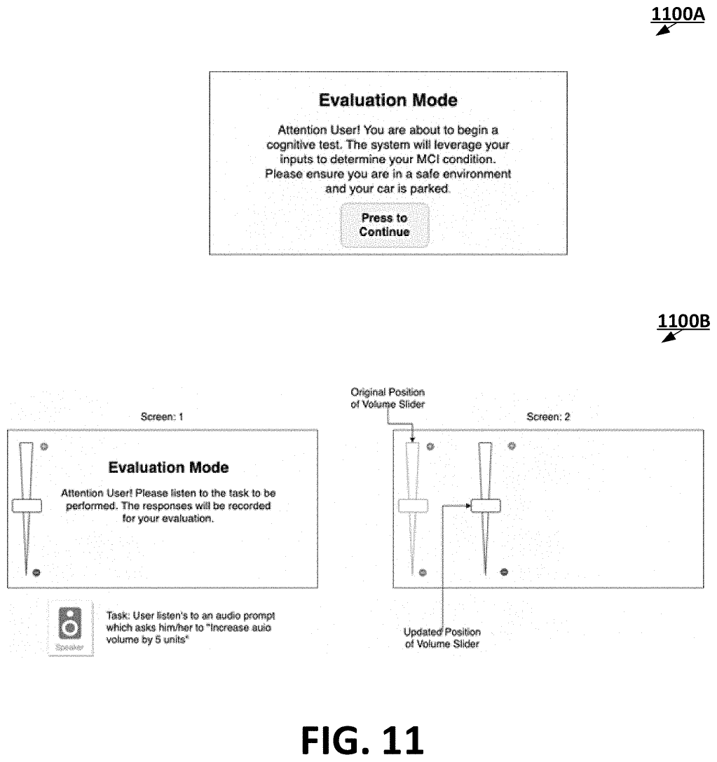

FIG. 11 depicts operational examples 1100A-B of a modified paired associates learning test. As depicted in 1100A of FIG. 11, the predictive data analysis computing entity 106 displays on a user interface associated with a client computing entity associated with the monitored individual a test notification notifying the monitored individual that a test is about to commence (e.g., start), along with instructions associated with the test. As depicted in 1100B, the predictive data analysis computing entity 106 transmits a notification (e.g., audio prompt) to a client device (e.g., client computing entity) associated with the monitored individual, providing instructions to perform one or more tasks. For example, as shown in 1100B, the task may be to increase the audio volume of a volume object displayed on the display screen of the user interface by 5 units. In some embodiments, the predictive data analysis computing entity 106 may change the position/location of the volume object on the display screen of the user interface subsequent to the instruction to perform the task (e.g., increase the audio volume) but prior to the monitored individual performing the task.

In some embodiments, the predictive data analysis computing entity 106 may record (e.g., store) the monitored individual's response. Additionally, the predictive data analysis computing entity 106 may determine, based at least in part on the monitored individual's response, one or more PAL observation data objects. In some embodiments, the one or more PAL observation data objects include one or more of observation data objects that describes the monitored individual's comprehension (e.g., understanding) of the task, one or more observation data objects that describes a reaction time, and/or the like. In some embodiments, the one or more PAL observation data objects are configured to be input variables to a machine learning model (e.g., an intermediate risk scoring machine learning model). In some embodiments, the predictive data analysis computing entity re-presents the task to the monitored individual up to a defined maximum number of times based at least in part on the monitored individual's response (e.g., a scenario where it is determined that the monitored individual made a mistake with respect to the task.)

In some embodiments, an intermediate intervention operation may be triggered in response to determining attentiveness anomalies with respect to the monitored individual. In the noted embodiments, the predictive data analysis computing entity 106 may be configured to detect anomalies with respect to the monitored individual's attentiveness during operation of associated vehicle based at least in part on one or more sensory measurements (e.g., captured by one or more in-vehicle sensors). As an example, a camera sensor located in the vehicle operated by the monitored individual may capture sensory data that describes when a traffic light signal turns red (e.g., traffic signal timestamp) and a brake sensor may capture sensory data that describes when the monitored individual began applying the brakes (e.g., braking timestamp). In the noted example, the predictive data analysis computing entity may process (e.g., correlate) the camera sensory data and the brake sensor sensory data to detect anomalies (e.g., inconsistencies) with respect to the monitored individual's attentiveness. For example, in some embodiments, the predictive data analysis computing entity 106 may correlate the traffic signal time stamp with the braking timestamp to detect anomalies (inconsistencies). As another example, an in-vehicle camera sensor facing the monitored individual operating (e.g., driving) the vehicle may be configured to monitor expressions (e.g., micro-expressions) of the monitored individual to determine the monitored individual's attentiveness.

In some embodiments, prior to performing the intermediate intervention operations (e.g., one or more tests), the predictive data analysis computing entity 106 evaluates whether it is safe to perform the intermediate intervention operations. In some embodiments, the predictive data analysis sends a notification to the monitored individual (e.g., via a client computing entity associated with the monitored individual) recommending/instructing the monitored individual to stop/park the vehicle. For example, in some embodiments, the predictive data analysis computing entity 106 confirms that the monitored individual is not distracted prior to performing the intervention operations (e.g., by confirming that the vehicle is parked, by executing an optional memory quiz that tests the drivers cognitive responses such as how long it takes to press selected buttons given a certain condition, evaluating and/or determining a path associated with the least danger to the monitored individual and other individuals nearby, and/or the like).

Returning to FIG. 5 at step/operation 505, subsequent to performing the one or more intermediate intervention operations, the predictive data analysis computing entity 106 identifies/receives one or more intermediate intervention response features associated with the one or more intermediate intervention operations, where the one more intermediate intervention response features may be determined based at least in part on the one or more RTI reaction time deficit data objects, the one or more MOT reaction time deficit data objects, and/or the one or more PAL observation data objects. The predictive data analysis computing entity 106 may include one or more processing engines configured for determining the one or more RTI reaction time deficit data objects, the one or more MOT reaction time deficit data objects, and/or the one or more PAL observation data objects. Additionally or alternatively, the one or more processing engines may be configured for extracting the intermediate intervention response features from the one or more RTI reaction time deficit data objects, the one or more MOT reaction time deficit data objects, and/or the one or more PAL observation data objects.

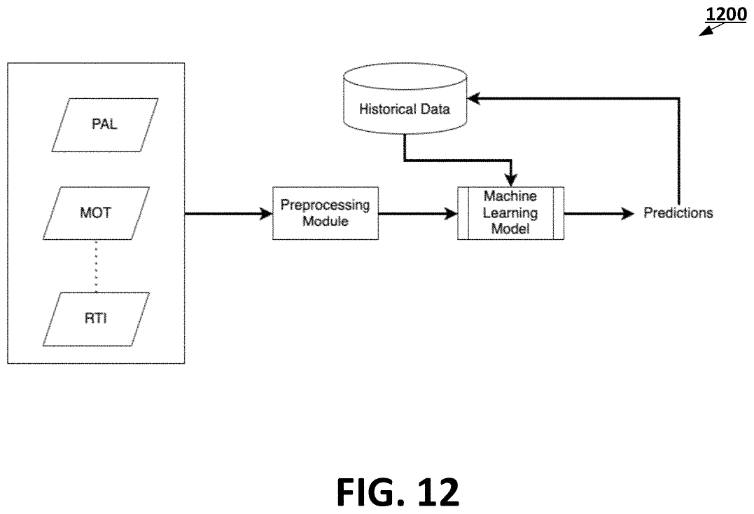

At step/operation 506, the predictive data analysis computing entity 106 generates an intermediate risk score. In some embodiments, the predictive data analysis computing entity 106 generates an intermediate risk score based at least in part on the one or more intermediate intervention response features using an intermediate risk scoring machine learning model of the hierarchical intervention recommendation machine learning framework. In some embodiments, the intermediate risk score may be indicative of the onset of a medical condition (e.g., mild cognitive impairment) with respect to a corresponding monitored individual. For example, in some embodiments, the intermediate risk score may be used to predict a given monitored individual's cognitive impairment state in advance (e.g., 7 days, 15 days, 30 days in advance). FIG. 12 depicts an operation example 1200 of an intermediate risk scoring machine learning model. As shown in FIG. 12, in some embodiments, the input to the intermediate risk scoring machine learning model includes the one or more intermediate intervention response features and historical data (e.g., historical prediction data)

At step/operation 507, the predictive data analysis computing entity 106 generates the adjusted risk score based at least in part on the real-time risk score and the intermediate risk score. In some embodiments, the predictive data analysis computing entity 106 generates the adjusted risk score based at least in part on the real-time risk score for the current window and the intermediate risk score utilizing a risk aggregation machine learning model of the hierarchical intervention recommendation machine learning framework. In some embodiments, the adjusted risk score may comprise an arithmetic ensemble model of the real-time risk score and the intermediate risk score. In an example embodiment, the arithmetic ensemble may comprise a weighted sum.

Accordingly, various embodiments of the present invention introduce techniques for improving operational reliability and computational efficiency of intervention recommendation predictive data analysis solutions by using a hierarchical intervention recommendation machine learning framework. As further described herein, a hierarchical intervention recommendation machine learning framework may limit real-time computational operations to those configured to generate an intermediate intervention score which is then used to perform one or more intermediate intervention operations, where executing final risk score determination operations is postponed until after executing one or more intermediate intervention operations. In this way, by utilizing these techniques, a predictive data analysis system can delay execution of some mission-critical operations to after a current time window, thus removing the number of real-time risk scoring operations that need to be performed. Accordingly, by using a hierarchical intervention recommendation machine learning framework, various embodiments of the present invention reduce the real-time operational load on intervention recommendation predictive data analysis solutions and thus improve operational reliability and computational efficiency of intervention recommendation predictive data analysis solutions.

In some embodiments determining the adjusted risk score may include performing the operation described by the below equation:

R=γ(αM₁+βM₂) Equation 3

In equation 3:
R is the adjusted risk score associated with the current prediction window,
M₁ is the real-time risk score for the current prediction window,
M₂ is the intermediate risk score,
γ is a normalizing factor (e.g., such that the score is in the range [0, 1]),
α is the weight value for the real-time risk score M₁, and
β is the weight value for the intermediate risk score M₂.

Returning to FIG. 4 at step/operation 403, the predictive data analysis computing entity 106 determines whether the adjusted risk score satisfies an adjusted risk score threshold (e.g., less than, equal to, and/or above). In some embodiments, the predictive data analysis computing entity 106 determines whether the adjusted risk score satisfies the adjusted risk score threshold by comparing the adjusted risk score to the adjusted risk score threshold.

At step/operation 404, in response to determining that the adjusted risk score satisfies the adjusted risk score threshold, the predictive data analysis computing entity 106 performs one or more prediction-based actions. For example, in some embodiments, in response to determining that the predictive data analysis computing entity 106 satisfies the adjusted risk score threshold, the predictive data analysis computing entity 106 performs one or more final intervention operations based at least in part on the adjusted risk score. In some embodiments, one or more modules (a next action recommender module) associated with the predictive data analysis computing entity 106 may be configured for performing the one or more final intervention operations. In some embodiments, performing the one more final intervention operations comprise utilizing one or more custom rules and/or inference (e.g., provided by the federated learning system/model).

In some embodiments, the one or more final intervention operations may be a medical test route intervention operation. In some embodiments, to perform a medical test route intervention operation, the predictive data analysis computing entity 106 identifies a path (e.g., alternative driving route) that is deemed safe for traversing by the monitored individual (e.g., a path that poses less danger to the monitored individual and individuals that might also be traversing the same path). In some embodiments, the path may be a route that the monitored individual may be (e.g., slightly) less familiar with, where, for example, additional unfamiliar traffic light signal and/or the like may be used to further assess the monitored individuals condition (e.g., based at least in part on a re-calculated adjusted risk score). Subsequent to identifying a safe path for the monitored individual to operate (e.g., drive) the associated vehicle, the predictive data analysis computing entity 106 determines a re-calculated adjusted risk score based at least in part on the performance of the monitored individual with respect to the path. To determine the recalculated adjusted risk score, the predictive data analysis computing entity 106 may be configured to repeat the steps/operations 401-402. The predictive data analysis computing entity 106 then compares the re-calculated adjusted risk score with the initial adjusted risk score (e.g., preceding adjusted risk score) to determine a similarity score.

In response to determining that the similarity score fails to satisfy a similarity score threshold (e.g., the re-calculated adjusted risk score fails to confirm the initial adjusted risk score), the predictive data analysis computing entity 106 may be configured to continue monitoring/evaluating the performance of the monitored individual. In some embodiments, the predictive data analysis computing entity 106 may increase the evaluation frequency (e.g., increasing the frequency at which adjusted risk scores are determined) for the monitored individual.

In response to determining that the similarity score satisfies the similarity score threshold, (e.g., the re-calculated adjusted risk score confirms the initial adjusted risk score is indicative of cognitive impairment), the predictive data analysis computing entity 106 transmits a notification to the monitored individual (e.g., a client computing entity associated with the monitored individual), where the notification recommends/instructs the monitored individual to park the vehicle or move the vehicle to the nearest safe location (e.g., hospital, parking lot, gas station, and/or the like).

In some embodiments, in response to determining that the monitored individual fails to follow the recommendation/instruction, the predictive data analysis computing entity 106 may be configured to continue evaluating/monitoring the performance of the monitored individual. In some embodiments, the predictive data analysis computing entity 106 may increase the evaluation frequency (e.g., increasing the frequency at which adjusted risk scores are determined) with respect to the monitored individual.

In some embodiments, the predictive data analysis computing entity 106 may be configured to transmit one or more notifications to one or more client computing entities associated with one or more individuals associated with the monitored individual (e.g., emergency contacts). In some embodiments, in response to determining that the adjusted risk score satisfies a defined adjusted risk score threshold, the predictive data analysis computing entity 106 may be configured to transmit a notification to one or more client computing entities associated with emergency services, one or more client computing entities associated with emergency contacts associated with the monitored individual, and/or the like. In some embodiments, the predictive data analysis computing entity 106 may be configured to trigger one or more autonomous vehicle systems (e.g., self-driving mode, auto parking mode) associated with the moving object (e.g. vehicle) operated by the monitored individual, trigger a bi-directional vehicle-to-vehicle (V2V) communication channel with nearby vehicles to warn the individuals associated with the nearby vehicles of compromised driving with respect to the monitored individual.

In some embodiments, the one or more final intervention operations may be an emergency response intervention operation. For example, the predictive data analysis computing entity 106 may perform an emergency response intervention operation in response to an emergency situation/scenario (e.g., vehicle accident) with respect to the monitored individual. In some embodiments, performing an emergency response intervention operation may comprise: (i) identifying sensory data such as heart rate, blood pressure, and/or other body sensory data (e.g., vitals), where the sensory data may be identified by utilizing the one or more sensors associated with the monitored individual (e.g., in-vehicle sensors), and/or the sensory data may be identified based at least part on the most recent sensory data captured by the in-vehicle sensors prior to the emergency scenario; (ii) evaluating the sensory data for anomalies; (iii) in response to determining anomalies with respect to the sensory data, transmitting a notification (e.g., alert) to a device/client computing entity associated with emergency services (e.g., first responders); and (iv) generating a high-importance medical data subset for the corresponding monitored individual, where a high-importance medical data subset may describe the most important medical history data (e.g., most important medications, most important medical treatments, most important prescriptions) associated with the monitored individual. In some embodiments, to identify the high-importance medical data subset, the predictive data analysis utilizes a longitudinal Electronic Health Record (EHR) data-based deep learning model such as a modified RETAIN, modified Weighted Adaptive Filtering Model, and/or the like.

For example, in some embodiments, to generate a high-importance medical data subset, the predictive data analysis computing entity 106 utilizes a high-importance data generation machine learning model (e.g., a trained multi-disease prediction model or a modified Weighted Adaptive Filtering Model) based at least in part on one or more historical data (e.g., Electronic Health Record data, medical claim data, prescription data, and/or the like) and current sensory data (e.g., current vitals such as blood pressure, heart rate, body temperature, and/or the like) for the monitored individual. In some embodiments, the predictive data analysis computing entity 106 may be configured to store and/or update the historical data (e.g., in a database/repository). In some embodiments, the predictive data analysis computing entity may be configured to perform one or more preprocessing operations that comprise preparing the historical data and the current sensory data for ingestion and/or analysis.

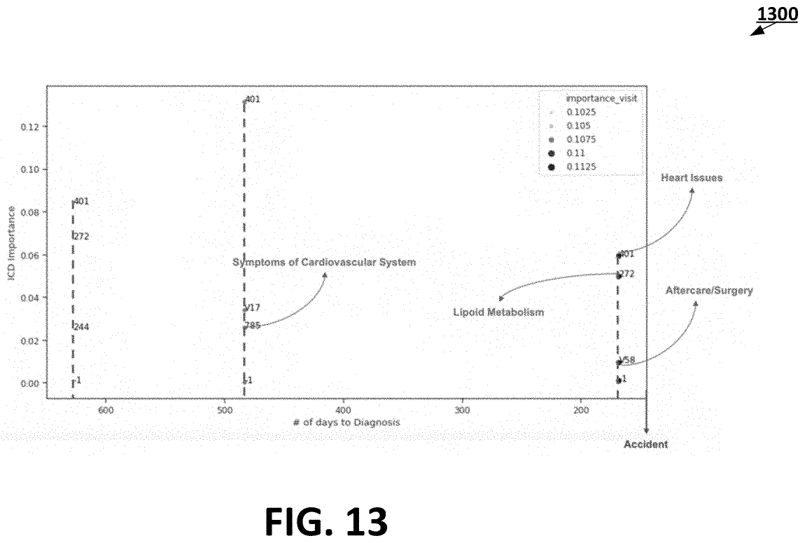

In some embodiments, the high-importance data generation machine learning model is a multi-attention model where the output of each analysis with respect to the high-importance data generation machine learning model includes: (i) fatality risk score/disease risk score and (ii) top features (e.g., top most important medical history data for the monitored individual)—which are generated based at least in part on attention weights, where the attention weights describe which historical data have the most impact for the current condition of the monitored individual—along with a visualization (e.g., on a user interface) for understanding the most important historical medical events/historical medical history data as shown in FIG. 13. FIG. 13 is an operational example 1300 of a high-importance medical data subset user interface. As shown in 1300 of FIG. 13, the predictive data analysis computing entity 106 displays the high-importance medical data subset on a user interface associated with a client computing entity (e.g., in-vehicle screen, client mobile device, emergency services mobile devices, and/or the like). As shown in 1300 of FIG. 13, the x-axis denotes the number of days before the emergency scenario (e.g., vehicle accident) and the y-axis denotes the importance of each ICD code (e.g., diagnosis code). In some embodiments the high-importance medical data subset may be provided to (e.g., shared with) emergency services (e.g., emergency responders) utilizing the high-importance medical data subset user interface. In some embodiments, the predictive data analysis computing entity 106 provides the high-importance medical data subset to emergency services utilizing auto generated messages. For example, in some embodiments, to provide the high-importance medical data subset to emergency services, the predictive data analysis computing entity 106 generates automated messages and transmits the generated automated messages to emergency services.

Moreover, various embodiments of the present invention introduce techniques for improving operational reliability and computational efficiency of intervention recommendation predictive data analysis solutions by using a hierarchical intervention recommendation machine learning framework. As further described herein, a hierarchical intervention recommendation machine learning framework may limit real-time computational operations to those configured to generate an intermediate intervention score which is then used to perform one or more intermediate intervention operations, where executing final risk score determination operations is postponed until after executing one or more intermediate intervention operations. In this way, by utilizing these techniques, a predictive data analysis system can delay execution of some mission-critical operations to after a current time window, thus removing the number of real-time risk scoring operations that need to be performed. Accordingly, by using a hierarchical intervention recommendation machine learning framework, various embodiments of the present invention reduce the real-time operational load on intervention recommendation predictive data analysis solutions and thus improve operational reliability and computational efficiency of intervention recommendation predictive data analysis solutions.

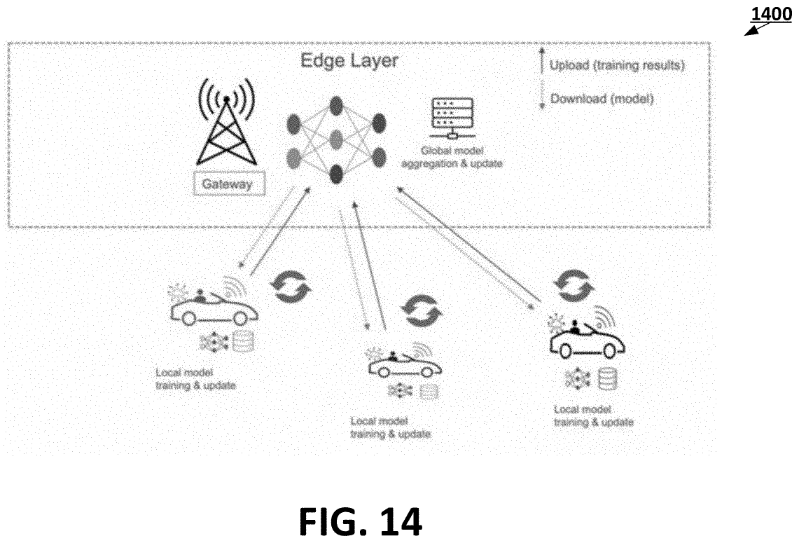

As noted above, in some embodiments, the predictive data analysis system 101 may be a federated learning system where a global model is trained with decentralized data generated by individual client computing entities. FIG. 14 depicts an operation example 1400 of a federated learning system according to some embodiments (e.g., training and deployment on the edge for the ensemble model, using a federated learning approach). As shown in FIG. 14, the central server may be configured to receive training data from each associated client computing entity associated with a monitored individual and deploy the model to the respective client computing entities.

### CONCLUSION

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A computer-implemented method for performing predictive data analysis operations using a hierarchical intervention recommendation machine learning framework, the computer-implemented method comprising:
Providing, using one or more processors, a global intermediate intervention score threshold to a primary computing entity, wherein the primary computing entity is configured to:
identify a real-time sensory timeseries data object associated with a current prediction window;
generate, using a real-time risk scoring machine learning model of the hierarchical intervention recommendation machine learning framework, and based at least in part on the real-time sensory timeseries data object and a global baseline sensory feature data object, a real-time risk score associated with the current prediction window;
generate, based at least in part on the real-time risk score, an intermediate intervention score;
in response to determining that the intermediate intervention score satisfies the global intermediate intervention score threshold:
perform one or more intermediate intervention operations,
subsequent to performing the one or more intermediate intervention operations, receive one or more intermediate intervention response features associated with the one or more intermediate intervention operations,
generate, using an intermediate risk scoring machine learning model of the hierarchical intervention recommendation machine learning framework, and based at least in part on the one or more intermediate intervention response features, an intermediate risk score,
generate, using a risk aggregation machine learning model of the hierarchical intervention recommendation machine learning framework, and based at least in part on the real-time risk score and the intermediate risk score, an adjusted risk score, and
perform one or more final intervention operations based at least in part on the adjusted risk score.

2. The computer-implemented method of claim 1, wherein:
the current prediction window is associated with N historical prediction windows,
each historical prediction window is associated with a historical risk score, and
generating the intermediate intervention score comprises:
determining a risk score timeseries data object based at least in part on the real-time risk score and each historical risk score,
determining an inferred upward linearity score associated with the risk score timeseries data object; and
generating the intermediate intervention score based at least in part on the real-time risk score and the inferred upward linearity score.

3. The computer-implemented method of claim 2, wherein determining the inferred upward linearity score comprises:
performing M iterations of a linearity score inference routine, wherein M=<N, and wherein each iteration comprises:
determining an iteratively enlarged subset of the risk score timeseries data object that is associated with the real-time risk score and most recent m historical risk scores, wherein m is initially set to one and incremented at the end of each iteration, and
determining, based at least in part on the iteratively enlarged subset and a linear trend data object for the iteratively enlarged subset, an iterative inferred upward linear score; and
determining the inferred upward linearity score based at least in part on each iterative inferred upward linear score.

4. The computer-implemented method of claim 1, wherein generating the real-time risk score comprises:
generating a real-time sensory feature data object based at least in part on the real-time sensory timeseries data object,
generating, based at least in part on the real-time sensory feature data object and the global baseline sensory feature data object, a real-time sensory deficit data object, and
generating the real-time risk score based at least in part on the real-time sensory deficit data object.

5. The computer-implemented method of claim 4, wherein:
the real-time sensory feature data object comprises a per-sensor real-time sensory feature for each sensor of one or more sensors, and
the global baseline sensory feature data object comprises a per-sensor baseline sensory feature for each sensor of the one or more sensors.

6. The computer-implemented method of claim 5, wherein:
the real-time sensory deficit data object comprises a per-sensory real-time sensory deficit value for each sensor of the one or more sensors,
generating the real-time sensory deficit data object comprises, for each sensor, determining the per-sensory real-time sensory deficit value based at least in part on the per-sensor real-time sensory feature for the sensor and the per-sensor baseline sensory feature for the sensor, and
generating the real-time risk score comprises generating the real-time risk score based at least in part on each per-sensor baseline sensory feature.

7. The computer-implemented method of claim 1, wherein:
the primary computing entity is a particular client computing entity, and
a server computing entity is configured to periodically provide global intermediate intervention score thresholds to the particular client computing entity.

8. The computer-implemented method of claim 7, wherein the server computing entity is configured to generate an optimal global intermediate intervention score threshold based at least in part on: (i) a statistical distribution measure of sensory data associated with a plurality of client computing entities associated with the server computing entity, and (ii) historical sensory data associated with the particular client computing entity.

9. The computer-implemented method of claim 1, wherein:
the primary computing entity is a server computing entity, and
providing the global intermediate intervention score thresholds comprises generating the global intermediate intervention score thresholds and retrieving generated global intermediate intervention score thresholds.

10. An apparatus for performing predictive data analysis operations using a hierarchical intervention recommendation machine learning framework, the apparatus comprising at least one processor and at least one memory including program code, the at least one memory and the program code configured to, with the processor, cause the apparatus to at least:
provide a global intermediate intervention score threshold to a primary computing entity, wherein the primary computing entity is configured to:
identify a real-time sensory timeseries data object associated with a current prediction window;
generate, using a real-time risk scoring machine learning model of the hierarchical intervention recommendation machine learning framework, and based at least in part on the real-time sensory timeseries data object and a global baseline sensory feature data object, a real-time risk score associated with the current prediction window;
generate, based at least in part on the real-time risk score, an intermediate intervention score;
in response to determining that the intermediate intervention score satisfies the global intermediate intervention score threshold:
perform one or more intermediate intervention operations,
subsequent to performing the one or more intermediate intervention operations, receive one or more intermediate intervention response features associated with the one or more intermediate intervention operations,
generate, using an intermediate risk scoring machine learning model of the hierarchical intervention recommendation machine learning framework, and based at least in part on the one or more intermediate intervention response features, an intermediate risk score,
generate, using a risk aggregation machine learning model of the hierarchical intervention recommendation machine learning framework, and based at least in part on the real-time risk score and the intermediate risk score, an adjusted risk score, and
perform one or more final intervention operations based at least in part on the adjusted risk score.

11. The apparatus of claim 10, wherein:
the current prediction window is associated with N historical prediction windows,
each historical prediction window is associated with a historical risk score, and
generating the intermediate intervention score comprises:
determining a risk score timeseries data object based at least in part on the real-time risk score and each historical risk score,
determining an inferred upward linearity score associated with the risk score timeseries data object; and
generating the intermediate intervention score based at least in part on the real-time risk score and the inferred upward linearity score.

12. The apparatus of claim 11, wherein determining the inferred upward linearity score comprises:
performing M iterations of a linearity score inference routine, wherein M=<N, and wherein each iteration comprises:
determining an iteratively enlarged subset of the risk score timeseries data object that is associated with the real-time risk score and most recent m historical risk scores, wherein m is initially set to one and incremented at the end of each iteration, and
determining, based at least in part on the iteratively enlarged subset and a linear trend data object for the iteratively enlarged subset, an iterative inferred upward linear score; and
determining the inferred upward linearity score based at least in part on each iterative inferred upward linear score.

13. The apparatus of claim 10, wherein generating the real-time risk score comprises:
generating a real-time sensory feature data object based at least in part on the real-time sensory timeseries data object,
generating, based at least in part on the real-time sensory feature data object and the global baseline sensory feature data object, a real-time sensory deficit data object, and
generating the real-time risk score based at least in part on the real-time sensory deficit data object.

14. The apparatus of claim 13, wherein:
the real-time sensory feature data object comprises a per-sensor real-time sensory feature for each sensor of one or more sensors, and
the global baseline sensory feature data object comprises a per-sensor baseline sensory feature for each sensor of the one or more sensors.

15. The apparatus of claim 14, wherein:
the real-time sensory deficit data object comprises a per-sensory real-time sensory deficit value for each sensor of the one or more sensors,
generating the real-time sensory deficit data object comprises, for each sensor, determining the per-sensory real-time sensory deficit value based at least in part on the per-sensor real-time sensory feature for the sensor and the per-sensor baseline sensory feature for the sensor, and
generating the real-time risk score comprises generating the real-time risk score based at least in part on each per-sensor baseline sensory feature.

16. The apparatus of claim 10, wherein:
the primary computing entity is a particular client computing entity, and
a server computing entity is configured to periodically provide global intermediate intervention score thresholds to the particular client computing entity.

17. The apparatus of claim 16, wherein the server computing entity is configured to generate an optimal global intermediate intervention score threshold based at least in part on: (i) a statistical distribution measure of sensory data associated with a plurality of client computing entities associated with the server computing entity, and (ii) historical sensory data associated with the particular client computing entity.

18. The apparatus of claim 10, wherein:
the primary computing entity is a server computing entity, and
providing the global intermediate intervention score threshold comprises generating the global intermediate intervention score thresholds and retrieving generated global intermediate intervention score thresholds.

19. A computer program product for performing predictive data analysis operations using a hierarchical intervention recommendation machine learning framework, the computer program product comprising at least one non-transitory computer-readable storage medium having computer-readable program code portions stored therein, the computer-readable program code portions configured to:
provide a global intermediate intervention score threshold to a primary computing entity, wherein the primary computing entity is configured to:
identify a real-time sensory timeseries data object associated with a current prediction window;
generate, using a real-time risk scoring machine learning model of the hierarchical intervention recommendation machine learning framework, and based at least in part on the real-time sensory timeseries data object and a global baseline sensory feature data object, a real-time risk score associated with the current prediction window;
generate, based at least in part on the real-time risk score, an intermediate intervention score;
in response to determining that the intermediate intervention score satisfies the global intermediate intervention score threshold:
perform one or more intermediate intervention operations,
subsequent to performing the one or more intermediate intervention operations, receive one or more intermediate intervention response features associated with the one or more intermediate intervention operations,
generate, using an intermediate risk scoring machine learning model of the hierarchical intervention recommendation machine learning framework, and based at least in part on the one or more intermediate intervention response features, an intermediate risk score,
generate, using a risk aggregation machine learning model of the hierarchical intervention recommendation machine learning framework, and based at least in part on the real-time risk score and the intermediate risk score, an adjusted risk score, and
perform one or more final intervention operations based at least in part on the adjusted risk score.

20. The computer program product of claim 19, wherein:
the current prediction window is associated with N historical prediction windows,
each historical prediction window is associated with a historical risk score, and
generating the intermediate intervention score comprises:
determining a risk score timeseries data object based at least in part on the real-time risk score and each historical risk score,
determining an inferred upward linearity score associated with the risk score timeseries data object; and
generating the intermediate intervention score based at least in part on the real-time risk score and the inferred upward linearity score.
